(19) United States
(12) Patent Application Publication
(10) Pub. No.: US 2026/0322456 A1
(43) Pub. Date: Oct. 15, 2026

(54) NETWORK PERFORMANCE MONITORING OF USER EQUIPMENT (UE) MACHINE LEARNING MODELS

(71) Applicant: QUALCOMM Incorporated, San Diego, CA (US)

(72) Inventors: Mohamed Fouad Ahmed MARZBAN, San Diego, CA (US); Tao LUO, San Diego, CA (US); Wooseok NAM, San Diego, CA (US)

(21) Appl. No.: 19/646,417

(22) Filed: Apr. 13, 2026

Related U.S. Application Data
(60) Provisional application No. 63/789,360, filed on Apr. 15, 2025.

(51) Int. Cl. H04B 7/06; H04B 17/318; H04L 41/16; H04W 24/10

(52) U.S. Cl. CPC H04B 7/0626; H04B 17/318; H04L 41/16; H04W 24/10

(57) ABSTRACT

This disclosure provides methods, components, devices and systems for network performance monitoring of user equipment (UE) machine learning (ML) models. For example, a UE may receive first signaling comprising an indication of a restriction of a set of measurement parameters for inclusion in a channel state information (CSI) prediction procedure, and the UE may input, into one or more ML models as part of the CSI prediction procedure, a plurality of measurements corresponding to a first plurality of communication resources in accordance with the restriction of the set of measurement parameters. The UE may obtain an indication of a predicted CSI associated with a second plurality of communication resources in accordance with an output of the one or more ML models and may report the indication of the predicted CSI to a network entity.

### CROSS REFERENCE

The present Application for Patent claims the benefit of U.S. Provisional Patent Application No. 63/789,360 by MARZBAN et al., entitled “NETWORK PERFORMANCE MONITORING OF USER EQUIPMENT (UE) MACHINE LEARNING MODELS,” filed Apr. 15, 2025, which is assigned to the assignee hereof, and which is expressly incorporated by reference herein.

### INTRODUCTION

This disclosure relates generally to wireless communication, and more specifically to systems, devices, methods, and techniques associated with measurement and reporting of channel state information (CSI) feedback for communication resources.

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving first signaling including an indication of a restriction of a set of measurement parameters for inclusion in a channel state information (CSI) prediction procedure, inputting, into one or more machine learning models as part of the CSI prediction procedure, a set of multiple measurements corresponding to a first set of multiple communication resources in accordance with the restriction of the set of measurement parameters, obtaining an indication of a predicted CSI associated with a second set of multiple communication resources in accordance with an output of the one or more machine learning models based on the set of measurement parameters, and reporting the indication of the predicted CSI to a network entity.

An apparatus for wireless communications at a UE is described. The apparatus for wireless communications may include one or more memories storing processor-executable code, one or more processors coupled with the one or more memories and configured to cause the UE to receive first signaling including an indication of a restriction of a set of measurement parameters for inclusion in a CSI prediction procedure, input, into one or more machine learning models as part of the CSI prediction procedure, a set of multiple measurements corresponding to a first set of multiple communication resources in accordance with the restriction of the set of measurement parameters, obtain an indication of a predicted CSI associated with a second set of multiple communication resources in accordance with an output of the one or more machine learning models based on the set of measurement parameters, and report the indication of the predicted CSI to a network entity.

A UE for wireless communications is described. The UE may include a processing system that includes processor circuitry and memory circuitry that stores code. The processing system may be configured to cause the UE to receive first signaling including an indication of a restriction of a set of measurement parameters for inclusion in a CSI prediction procedure, input, into one or more machine learning models as part of the CSI prediction procedure, a set of multiple measurements corresponding to a first set of multiple communication resources in accordance with the restriction of the set of measurement parameters, obtain an indication of a predicted CSI associated with a second set of multiple communication resources in accordance with an output of the one or more machine learning models based on the set of measurement parameters, and report the indication of the predicted CSI to a network entity.

Another UE for wireless communications is described. The UE may include means for receiving first signaling including an indication of a restriction of a set of measurement parameters for inclusion in a CSI prediction procedure, means for inputting, into one or more machine learning models as part of the CSI prediction procedure, a set of multiple measurements corresponding to a first set of multiple communication resources in accordance with the restriction of the set of measurement parameters, means for obtaining an indication of a predicted CSI associated with a second set of multiple communication resources in accordance with an output of the one or more machine learning models based on the set of measurement parameters, and means for reporting the indication of the predicted CSI to a network entity.

A non-transitory computer-readable medium storing code for wireless communications is described. The code may include instructions executable by one or more processors to receive first signaling including an indication of a restriction of a set of measurement parameters for inclusion in a CSI prediction procedure, input, into one or more machine learning models as part of the CSI prediction procedure, a set of multiple measurements corresponding to a first set of multiple communication resources in accordance with the restriction of the set of measurement parameters, obtain an indication of a predicted CSI associated with a second set of multiple communication resources in accordance with an output of the one or more machine learning models based on the set of measurement parameters, and report the indication of the predicted CSI to a network entity.

In some examples of the method, UEs, and non-transitory computer-readable medium described herein, the CSI prediction procedure includes a prediction, via the output of the one or more machine learning models, of one or more communication beams, an interference level, CSI, a synchronization signal block resource indicator (SSBRI), a reference signal received power (RSRP), a signal to interference plus noise (SINR) value, a channel quality indicator (CQI) value, a precoding matrix indicator (PMI), a rank indicator (RI), a modulation and coding scheme (MCS), or any combination thereof.

Some examples of the method, UEs, and non-transitory computer-readable medium described herein may further include operations, features, means, or instructions for transmitting an inference report to a network entity, where the inference report includes the indication of the predicted CSI and an indication of the set of multiple measurements.

Some examples of the method, UEs, and non-transitory computer-readable medium described herein may further include operations, features, means, or instructions for performing one or more CSI measurements of the second set of multiple communication resources, comparing the one or more CSI measurements to the predicted CSI, the predicted CSI in accordance with the CSI prediction procedure, and transmitting a measurement report including an indication of a difference, or a similarity, or both between the one or more CSI measurements and the predicted CSI.

Some examples of the method, UEs, and non-transitory computer-readable medium described herein may further include operations, features, means, or instructions for receiving second signaling including an indication of one or more model management procedures in accordance with the measurement report.

In some examples of the method, UEs, and non-transitory computer-readable medium described herein, the difference includes a mean squared error value between the one or more CSI measurements and the predicted CSI.

Some examples of the method, UEs, and non-transitory computer-readable medium described herein may further include operations, features, means, or instructions for receiving second signaling that indicates whether to apply the restriction of the set of measurement parameters associated with the CSI prediction procedure.

Some examples of the method, UEs, and non-transitory computer-readable medium described herein may further include operations, features, means, or instructions for inputting, into the one or more machine learning models as part of the CSI prediction procedure, an additional set of multiple measurements corresponding to a second set of communication resources different from the set of multiple measurements in accordance with the second signaling, where the second signaling indicates an absence of the restriction of the set of measurement parameters.

Some examples of the method, UEs, and non-transitory computer-readable medium described herein may further include operations, features, means, or instructions for receiving a set of multiple reference signals associated with the first set of multiple communication resources, where the set of multiple reference signals may be in accordance with the set of measurement parameters and measuring the set of multiple reference signals, where the set of multiple measurements included in the CSI prediction procedure may be in accordance with the set of multiple reference signals.

In some examples of the method, UEs, and non-transitory computer-readable medium described herein, the restriction of the set of measurement parameters indicates a quantity of beams, or one or more measurement types, or a time separation between measurements, or a quantity of frequency sub-channels, or a frequency separation between one or more measurements of the set of multiple measurements, or any combination thereof for inclusion in the CSI prediction procedure.

In some examples of the method, UEs, and non-transitory computer-readable medium described herein, the one or more measurement types include synchronization signal block (SSB) measurements, or CSI reference signal (CSI-RS) measurements, or CSI interference measurements (CSI-IM), or any combination thereof.

In some examples of the method, UEs, and non-transitory computer-readable medium described herein, the first signaling includes radio resource control signaling, or medium access control control element (MAC-CE) signaling, or downlink control information, or any combination thereof.

A method for wireless communications by a UE is described. The method may include receiving signaling including an indication of a reporting configuration associated with a CSI prediction procedure, inputting, into one or more machine learning models as part of the CSI prediction procedure, a set of multiple measurements corresponding to a first set of multiple communication resources, obtaining an indication of a predicted CSI associated with a second set of multiple communication resources in accordance with an output of the one or more machine learning models based on the set of multiple measurements, and transmitting a report including an indication of the set of multiple measurements in accordance with the reporting configuration.

An apparatus for wireless communications at a UE is described. The apparatus for wireless communications may include one or more memories storing processor-executable code, one or more processors coupled with the one or more memories and configured to cause the UE to receive signaling including an indication of a reporting configuration associated with a CSI prediction procedure, input, into one or more machine learning models as part of the CSI prediction procedure, a set of multiple measurements corresponding to a first set of multiple communication resources, obtain an indication of a predicted CSI associated with a second set of multiple communication resources in accordance with an output of the one or more machine learning models based on the set of multiple measurements, and transmit a report including an indication of the set of multiple measurements in accordance with the reporting configuration.

A UE for wireless communications is described. The UE may include a processing system that includes processor circuitry and memory circuitry that stores code. The processing system may be configured to cause the UE to receive signaling including an indication of a reporting configuration associated with a CSI prediction procedure, input, into one or more machine learning models as part of the CSI prediction procedure, a set of multiple measurements corresponding to a first set of multiple communication resources, obtain an indication of a predicted CSI associated with a second set of multiple communication resources in accordance with an output of the one or more machine learning models based on the set of multiple measurements, and transmit a report including an indication of the set of multiple measurements in accordance with the reporting configuration.

Another UE for wireless communications is described. The UE may include means for receiving signaling including an indication of a reporting configuration associated with a CSI prediction procedure, means for inputting, into one or more machine learning models as part of the CSI prediction procedure, a set of multiple measurements corresponding to a first set of multiple communication resources, means for obtaining an indication of a predicted CSI associated with a second set of multiple communication resources in accordance with an output of the one or more machine learning models based on the set of multiple measurements, and means for transmitting a report including an indication of the set of multiple measurements in accordance with the reporting configuration.

A non-transitory computer-readable medium storing code for wireless communications is described. The code may include instructions executable by one or more processors to receive signaling including an indication of a reporting configuration associated with a CSI prediction procedure, input, into one or more machine learning models as part of the CSI prediction procedure, a set of multiple measurements corresponding to a first set of multiple communication resources, obtain an indication of a predicted CSI associated with a second set of multiple communication resources in accordance with an output of the one or more machine learning models based on the set of multiple measurements, and transmit a report including an indication of the set of multiple measurements in accordance with the reporting configuration.

In some examples of the method, UEs, and non-transitory computer-readable medium described herein, the report includes the indication of the predicted CSI.

Some examples of the method, UEs, and non-transitory computer-readable medium described herein may further include operations, features, means, or instructions for performing one or more CSI measurements of the second set of multiple communication resources, comparing the one or more CSI measurements to the predicted CSI, the predicted CSI in accordance with the CSI prediction procedure, and transmitting a measurement report including an indication of a difference between the one or more CSI measurements and the predicted CSI.

Some examples of the method, UEs, and non-transitory computer-readable medium described herein may further include operations, features, means, or instructions for receiving second signaling including an indication of one or more model management procedures associated with the one or more machine learning models in accordance with the measurement report.

Some examples of the method, UEs, and non-transitory computer-readable medium described herein may further include operations, features, means, or instructions for receiving a set of multiple reference signals associated with the first set of multiple communication resources and measuring the set of multiple reference signals to obtain the set of multiple measurements, where the report indicates the set of multiple reference signals.

In some examples of the method, UEs, and non-transitory computer-readable medium described herein, the report includes an indication of one or more skipped measurements of a second set of multiple measurements including the set of multiple measurements, the one or more skipped measurements corresponding to one or more reference signals of the set of multiple reference signals.

Some examples of the method, UEs, and non-transitory computer-readable medium described herein may further include operations, features, means, or instructions for obtaining one or more metrics associated with communications between the UE and a network entity in accordance with the predicted CSI and transmitting the report based on the one or more metrics satisfying one or more performance thresholds.

Some examples of the method, UEs, and non-transitory computer-readable medium described herein may further include operations, features, means, or instructions for receiving second signaling indicating the one or more performance thresholds.

In some examples of the method, UEs, and non-transitory computer-readable medium described herein, the indication of the set of multiple measurements includes an indication of a quantity of beams included in the CSI prediction procedure, an indication of one or more measurement types corresponding to the set of multiple measurements, an indication of a time separation between each measurement of the set of multiple measurements, an indication of a set of beam identifiers associated with the quantity of beams, an indication of a spatial separation between each beam of the quantity of beams, an indication of one or more frequency resources associated with the quantity of beams, or any combination thereof.

In some examples of the method, UEs, and non-transitory computer-readable medium described herein, the one or more measurement types include SSB measurements, CSI-RS measurements, CSI-IM, or any combination thereof.

A method for wireless communication by a network entity is described. The method may include output first signaling including an indication of a restriction of a set of measurement parameters for inclusion in a CSI prediction procedure at a UE and obtaining a report from the UE including an indication of a predicted CSI of a set of multiple communication resources in accordance with the CSI prediction procedure and the restriction of the set of measurement parameters.

An apparatus for wireless communications at a network entity is described. The apparatus for wireless communications may include one or more memories storing processor-executable code, one or more processors coupled with the one or more memories and configured to cause the network entity to output first signal including an indication of a restriction of a set of measurement parameters for inclusion in a CSI prediction procedure at a UE and obtain a report from the UE including an indication of a predicted CSI of a set of multiple communication resources in accordance with the CSI prediction procedure and the restriction of the set of measurement parameters.

A network entity for wireless communication is described. The network entity may include a processing system that includes processor circuitry and memory circuitry that stores code. The processing system may be configured to cause the network entity to output first signal including an indication of a restriction of a set of measurement parameters for inclusion in a CSI prediction procedure at a UE and obtain a report from the UE including an indication of a predicted CSI of a set of multiple communication resources in accordance with the CSI prediction procedure and the restriction of the set of measurement parameters.

Another network entity for wireless communication is described. The network entity may include means for output first signaling including an indication of a restriction of a set of measurement parameters for inclusion in a CSI prediction procedure at a UE and means for obtaining a report from the UE including an indication of a predicted CSI of a set of multiple communication resources in accordance with the CSI prediction procedure and the restriction of the set of measurement parameters.

A non-transitory computer-readable medium storing code for wireless communication is described. The code may include instructions executable by one or more processors to output first signal including an indication of a restriction of a set of measurement parameters for inclusion in a CSI prediction procedure at a UE and obtain a report from the UE including an indication of a predicted CSI of a set of multiple communication resources in accordance with the CSI prediction procedure and the restriction of the set of measurement parameters.

In some examples of the method, network entities, and non-transitory computer-readable medium described herein, the report includes an indication of a subset of the set of measurement parameters included in the CSI prediction procedure used to obtain the predicted CSI.

Some examples of the method, network entities, and non-transitory computer-readable medium described herein may further include operations, features, means, or instructions for obtaining a measurement report including an indication of a difference between one or more CSI measurements of the set of multiple communication resources and the predicted CSI, the predicted CSI based on the CSI prediction procedure at the UE.

In some examples of the method, network entities, and non-transitory computer-readable medium described herein, output second signaling indicating whether to apply the restriction of the set of measurement parameters associated with the CSI prediction procedure.

A method for wireless communication by a network entity is described. The method may include output first signaling including an indication of a reporting configuration associated with a CSI prediction procedure at a UE and obtaining, in accordance with the reporting configuration, a report including an indication of a set of measurements that were used as input to the CSI prediction procedure to obtain predicted CSI for a set of multiple communication resources.

An apparatus for wireless communications at a network entity is described. The apparatus for wireless communications may include one or more memories storing processor-executable code, one or more processors coupled with the one or more memories and configured to cause the network entity to output first signal including an indication of a reporting configuration associated with a CSI prediction procedure at a UE and obtain, in accordance with the reporting configuration, a report including an indication of a set of measurements that were used as input to the CSI prediction procedure to obtain predicted CSI for a set of multiple communication resources.

A network entity for wireless communication is described. The network entity may include a processing system that includes processor circuitry and memory circuitry that stores code. The processing system may be configured to cause the network entity to output first signal including an indication of a reporting configuration associated with a CSI prediction procedure at a UE and obtain, in accordance with the reporting configuration, a report including an indication of a set of measurements that were used as input to the CSI prediction procedure to obtain predicted CSI for a set of multiple communication resources.

Another network entity for wireless communication is described. The network entity may include means for output first signaling including an indication of a reporting configuration associated with a CSI prediction procedure at a UE and means for obtaining, in accordance with the reporting configuration, a report including an indication of a set of measurements that were used as input to the CSI prediction procedure to obtain predicted CSI for a set of multiple communication resources.

A non-transitory computer-readable medium storing code for wireless communication is described. The code may include instructions executable by one or more processors to output first signal including an indication of a reporting configuration associated with a CSI prediction procedure at a UE and obtain, in accordance with the reporting configuration, a report including an indication of a set of measurements that were used as input to the CSI prediction procedure to obtain predicted CSI for a set of multiple communication resources.

In some examples of the method, network entities, and non-transitory computer-readable medium described herein, the report includes an indication of the predicted CSI.

Some examples of the method, network entities, and non-transitory computer-readable medium described herein may further include operations, features, means, or instructions for obtaining a measurement report including an indication of a difference between one or more CSI measurements of the set of multiple communication resources and the predicted CSI, the predicted CSI based on the CSI prediction procedure at the UE.

Some examples of the method, network entities, and non-transitory computer-readable medium described herein may further include operations, features, means, or instructions for outputting a first set of multiple reference signals, where the set of measurements associated with the CSI prediction procedure may be in accordance with the first set of multiple reference signals and outputting a second set of multiple reference signals based on the report.

### BRIEF DESCRIPTION OF THE DRAWINGS

FIG. 1 shows an example of a wireless communication system.

FIG. 2 shows an example of a signaling diagram that supports network performance monitoring of user equipment (UE) machine learning (ML) models.

FIG. 3 shows an example of a ML process that supports network performance monitoring of UE ML models.

FIG. 4 shows an example of a process flow that supports network performance monitoring of UE ML models.

FIG. 5 shows an example of a process flow that supports network performance monitoring of UE ML models.

FIG. 6 shows a block diagram of a processing system that supports network performance monitoring of UE ML models.

FIG. 7 shows a diagram of a system including a device that supports network performance monitoring of UE ML models.

FIG. 8 shows a block diagram of a processing system that supports network performance monitoring of UE ML models.

FIG. 9 shows a diagram of a system including a device that supports network performance monitoring of UE ML models.

FIGS. 10 through 13 show flowcharts illustrating methods that support network performance monitoring of UE ML models.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may utilize one or more machine learning (ML) models to determine (e.g., predict) one or more communication parameters associated with one or more communication beams. In some cases, the one or more communication beams may correspond to an operating environment of the UE, or a configuration of the UE. For example, the UE may input one or more measurements of one or more communication beams into a ML model, and the UE may obtain, via an output of the ML model, an indication (e.g., a prediction) of one or more additional communication beams different than the communication beams associated with the input measurements. The UE, a network entity, or both may monitor a performance of the ML model by performing one or more measurements of the predicted beams and comparing the measurements to predicted metrics of the predicted beams. In some cases, the network entity may determine whether the ML model is performing in accordance with an environment of the UE. For example, the ML model may produce inaccurate beam prediction results (e.g., beam prediction results that fail to satisfy one or more key performance indicators (KPIs), or a mismatch between measured data and ML model predicted data) based on the UE operating in an environment different from an environment in which the ML model was trained. Accordingly, the network entity may perform, or indicate for the UE to perform, one or more model management procedures including retraining the ML model, switching to a different ML model, reverting (e.g., falling-back) to non-ML operations, activating or deactivating the ML model or portions of the ML model, or the like in accordance with the performance of the ML model.

However, in some cases, the UE may autonomously (e.g., without explicit instruction or control from the network) adjust the input to the ML model (e.g., to decrease a power consumption of the UE, or the like). For example, the UE may input a reduced quantity of measurements into the ML model (e.g., compared to a quantity of available reference signals), which may result in a relatively decreased performance of the model (e.g., the ML model may perform poorly despite operating in an appropriate environment for the ML model). In some examples, network entity may output a sufficient quantity of measurements (e.g., in an appropriate environment for the ML model) for the UE to achieve a non-degraded performance by including the measurements as inputs to the ML model. For example, the UE may achieve the non-degraded performance by including a greater quantity of measurements of the available reference signals as inputs to the ML model without the network entity outputting additional reference signals, or without performing ML model management procedures, or both. However, the network entity, the UE, or both may perform the model management procedures unnecessarily based on the UE inputting the reduced quantity of measurements and on the decreased performance of the UE ML model, which may incur additional overhead, or may degrade performance based on switching to a different ML model. Additionally, or alternatively, the network entity may output an increased quantity of reference signals (e.g., compared to an initial quantity associated with the measurements input to the ML model) based on the performance of the ML model, which may be extraneous (e.g., there may already be a sufficient quantity of reference signals for the UE to achieve a greater performance of the ML model) and may increase overhead.

Aspects of the subject matter described in this disclosure relate to network management of performance monitoring of UE ML models. For example, a network entity may output signaling indicating a set of measurements (e.g., a restriction to a set of measurements) for a UE to include as inputs to a ML model as part of a beam management prediction procedure (e.g., a channel state information (CSI) prediction procedure including prediction of CSI for a set of communication resources, or the like). In some cases, the network may indicate a quantity of measurements, a periodicity of measurements, one or more types of measurements, or the like for the UE to input to the ML model. Accordingly, the UE may obtain, from the ML model, an indication of one or more predicted beams based on the signaled set of measurements (e.g., based on the restriction of the measurements the UE may include as inputs to the ML model).

Additionally, or alternatively, the network entity may output signaling indicating a reporting configuration, which may include a set of parameters for the UE to report that are associated with the measurements input by the UE to the ML model. For example, the UE may transmit, via a report, a quantity of measurements, a periodicity of measurements, a type of measurements, or the like input by the UE to the ML model (e.g., during an inference process of a beam management prediction process). In such examples, the network entity may determine whether the ML model performance is based on the measurements input by the UE (e.g., a quantity of measurements, or a periodicity of the measurements), or on an environment of the UE changing compared to a training of the ML model, one or more operating conditions of the UE, a quantity of reference signals (e.g., available reference signals), or a periodicity of the reference signals, among other examples. Accordingly, the network entity may refrain from outputting additional reference signaling or performing model management procedures unnecessarily. Additionally, or alternatively, the network entity may indicate a set of measurement parameters for the UE to input to the ML model in accordance with the performance of the ML model and the report, which may relatively improve ML model performance, among other examples. By communicating in accordance with accurate ML model predictions, the UE, the network entity, or both may perform communications via communication resources without first performing one or more procedures (e.g., significant or extensive procedures) to determine (e.g., calculate or compute) CSI associated with the communication resources, which may reduce overhead and latency, among other improvements.

Particular aspects of the subject matter described in this disclosure demonstrate improvements in network performance monitoring of UE ML models. In some examples, by communicating information indicating the set of measurements utilized by the UE as inputs to the ML model as part of the beam management prediction procedure, the described techniques can be used to relatively improve UE ML model performance while refraining from increasing an overhead (e.g., a signaling or a processing overhead) of the network entity, the UE, or both, unnecessarily. For example, the network entity may refrain from performing model management procedures based on a performance degradation of the UE ML model due to a quantity of measurements, or a measurement type, input by the UE, which may reduce overhead (e.g., processing overhead). Additionally, or alternatively, the network entity may refrain from outputting additional reference signaling based on the degradation of the UE ML model caused by the UE including a quantity of reference signals that is less than a quantity of available reference signals, which may relatively reduce overhead (e.g., signaling overhead) and increase NES.

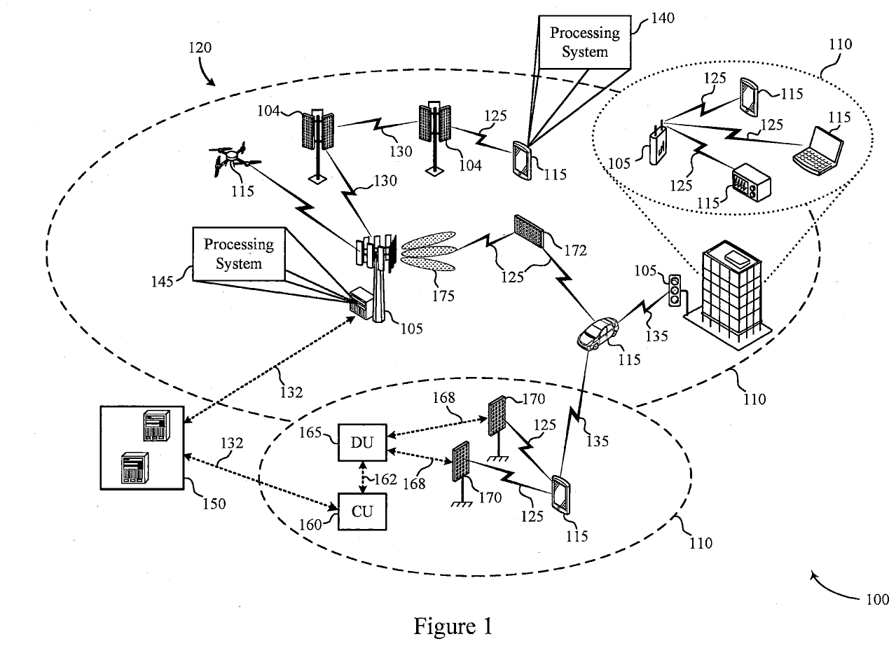

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a SBFD configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Particular aspects of the subject matter described in this disclosure demonstrate improvements in network performance monitoring of UE ML models. In some examples, by communicating information indicating the set of measurements utilized by the UE 115 as inputs to the ML model (e.g., restriction of the set of measurements) as part of the beam management prediction procedure, the described techniques can be used to relatively improve UE ML model performance while refraining from increasing an overhead (e.g., a signaling or a processing overhead) of the network entity 105, the UE 115, or both, unnecessarily. For example, the network entity 105 may refrain from performing model management procedures based on a performance degradation of the UE 115 ML model due to a quantity of measurements, or a measurement type, input by the UE 115, which may reduce overhead (e.g., processing overhead). Additionally, or alternatively, the network entity 105 may refrain from outputting additional reference signaling based on the degradation of the UE 115 ML model caused by the UE 115 including a quantity of reference signals that is less than a quantity of available reference signals, which may relatively reduce overhead (e.g., signaling overhead).

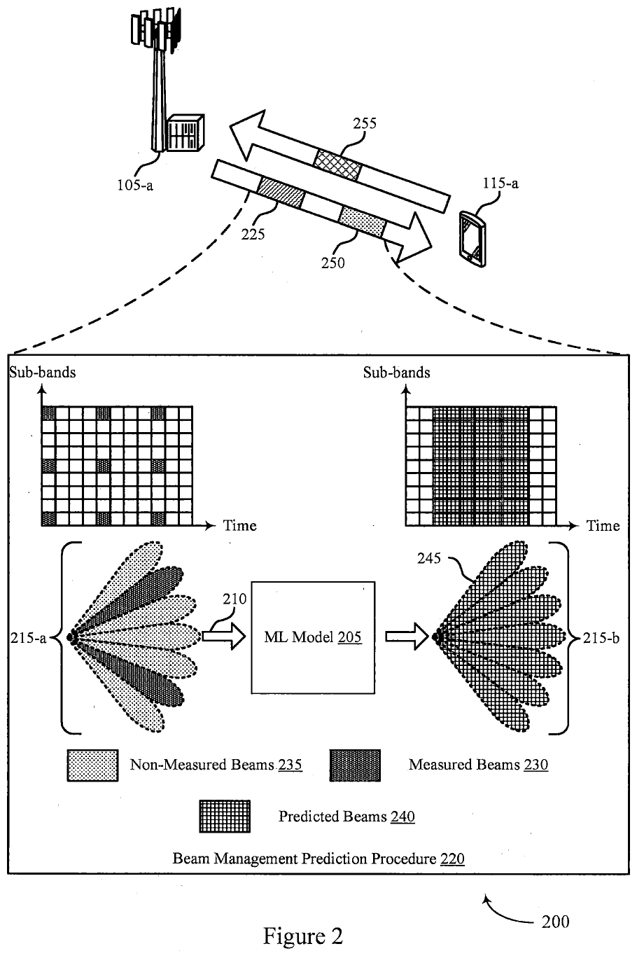

FIG. 2 shows an example of a signaling diagram 200 that supports network performance monitoring of UE ML models in accordance with one or more aspects of the present disclosure. Aspects of the signaling diagram 200 may implement or be implemented by aspects of the wireless communication system 100. For example, the signaling diagram 200 may include a UE 115-a and a network entity 105-a, which may be examples of the UE 115 and the network entity 105 respectively.

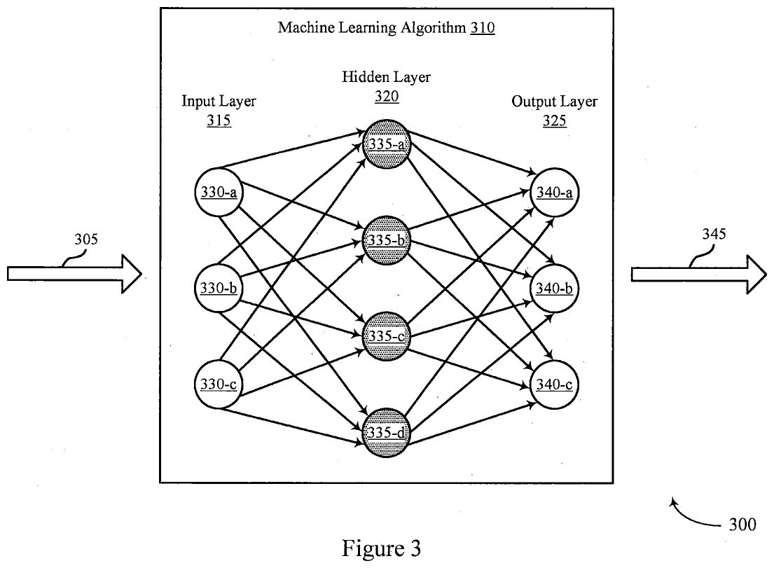

In some cases, the UE 115-a, the network entity 105-a, or both may utilize one or more ML models 205 further described herein with reference to FIG. 3 to perform one or more operations. In such cases, the UE 115-a, the network entity 105-a, or both may perform ML model monitoring (e.g., AI/ML model monitoring), which may include monitoring for a mismatch between measured data and ML model 205 data (e.g., data/concept drift, concept drift detection, or learning under concept drift) after the ML model 205 has been deployed (e.g., trained and implemented). The UE 115-a, the network entity 105-a, or both may utilize the ML model 205 associated with a desirable data distribution (e.g., distribution of a training dataset), for which it is designed to operate. For example, the UE 115-a may utilize the ML model 205 in other environments or operating conditions different than environments and operating conditions under which the model has been trained, which may cause a performance of the ML model 205 to be significantly degraded. In such examples, the UE 115-a, the network entity 105-a, or both may perform monitoring of the ML model 205 performance (e.g., using certain metrics) to keep the model in the desirable operation scenario.

In some cases, the UE 115-a, the network entity 105-a, or both may detect model drift of the ML model 205 based on performing the monitoring and may perform one or more actions when the data drift is detected or low ML model performance is observed. For example, the UE 115-a or the network entity 105-a may indicate, perform, or both, switching between different ML models or reverting (e.g., fallback) to non-ML operation, activating or deactivating branches in the ML model 205, performing online re-training (e.g., fine tuning) of the ML model 205, or performing a ML model transfer from the network entity 105-a to the UE 115-a, among other examples.

In some cases, the UE 115-a, the network entity 105-a, or both may perform the monitoring in accordance with an inference accuracy associated with one or more performance metrics related to intermediate KPIs, a system performance including metrics related to system performance KPIs, monitoring based on data distribution, input-based monitoring (e.g., monitoring the validity of the AI/ML input, out-of-distribution detection, drift detection of input data, or checking signal to noise ratio (SNR) or delay spread), output-based monitoring (e.g., drift detection of output data), or monitoring based on an applicable condition of the respective device utilizing the ML model 205. In such cases, the network entity 105-a, the UE 115-a, or both may perform monitoring metric calculation (e.g., to obtain the KPI metrics), which may include calculating metrics associated with accuracy and relevance (e.g., how well does the given monitoring metric/methods reflect the model and system performance), overhead (e.g., signaling overhead associated with model monitoring), complexity (e.g., computation and memory cost for model monitoring), latency (e.g., timeliness of monitoring result from model failure to action), or power consumption, among other examples of KPIs. In some cases, the UE 115-a, the network entity 105-a, or both may compute different KPIs for different model monitoring approaches.

In some cases, the network entity 105-a, the UE 115-a, or both may utilize the ML model 205 for beam management (e.g., beam management procedures). In some cases, the UE 115-a may perform UE-side model monitoring including monitoring performance metrics of the ML model 205 and determining (e.g., making decisions of) model selection, activation or deactivation, switching, or fallback operation. Additionally, or alternatively, the network entity 105-a may perform network-side model monitoring including monitoring performance metrics of the ML model 205 (e.g., model performance at the network entity 105-a or the UE 115-a) and determining (e.g., making decisions of) model selection, activation or deactivation, switching, or fallback operation. In some cases, the network entity 105-a and the UE 115-a may perform hybrid model monitoring. In such cases, the UE may monitor the performance metrics of the ML model 205 and the network entity 105-a may determine (e.g., make decisions of) model selection, activation or deactivation, switching, or fallback operation.

In some cases, in functionality-based life cycle management (LCM), the network entity 105-a may indicate an activation, deactivation, fallback, or switching of AI/ML functionality via one or more signaling types (e.g., RRC, MAC control element (MAC-CE), or DCI). In some cases, the UE may perform model-level LCM for the ML model 205 (e.g., based on one or more models not being identified at the network). For functionality identification, there may be either one or more than one functionality defined within an AI/ML-enabled feature (e.g., where an AI/ML-enabled feature is a feature where AI/ML may be used). In such cases, the UE 115-a may utilize one AI/ML model (e.g., the ML model 205) for the functionality, or UE may have multiple AI/ML models for the functionality.

In some cases, the network entity 105-a and the UE 115-a may perform a first type of ML model performance monitoring (e.g., Type 1 performance monitoring). In such cases, the network entity 105-a may transmit signaling to the UE 115-a indicating configurations for measurements, reporting, or both, and the UE 115-a may perform one or more different operations in accordance with the configurations. For example, in a first option for network-side performance monitoring, the UE 115-a may perform one or more measurements 210 to monitor the performance of the ML model 205, and the UE 115-a may transmit a report indicating the measurements 210, and the network entity 105-a may calculate the performance metrics based on the report. In a second option for UE-assisted performance monitoring, the UE 115-a may calculate the performance metrics based on the measurements 210 and may report the performance metrics to network entity 105-a, or may report an event to the network entity 105-a based on the performance metrics. In some cases, the network entity 105-a may output an indication for the UE 115-a to perform one or more model management procedures (e.g., LCM operations). For example, the network entity 105-a may determine LCM decisions when performing the first type of ML model performance monitoring.

In some cases, the network entity 105-a and the UE 115-a may perform a second type of ML model performance monitoring (e.g., Type 2 performance monitoring). Accordingly, the UE 115-a may transmit an indication (e.g., an indication, request, or report) to the network entity 105-a for performance monitoring (e.g., or the UE 115-a may refrain from transmitting the indication). Accordingly, the network entity 105-a may transmit signaling to the UE 115-a indicating configurations for measurements, reporting, or both. In some cases, where the UE 115-a may perform UE-side model monitoring, the UE 115-a may determine (e.g., make decisions) of model selection, activation, deactivation, switching, or fallback operation, among other examples.

In some cases, the UE 115-a, the network entity 105-a, or both may utilize the ML model 205 for CSI prediction. In such cases, the UE 115-a, the network entity 105-a, or both may utilize one or more channel or interference measurements 210 (e.g., synchronization signal block (SSB), CSI-RS, or CSI interference measurements (CSI-IM)) associated with a first set of resources into the ML model 205 as an input to a CSI prediction algorithm to predict the CSI on a second set of resources. For example, the UE 115-a, the network entity 105-a, or both may input relatively sparse channel measurements 210 (e.g., corresponding to a subset of slots, sub-bands, or beams 215) into the ML model 205 to obtain, as an output of the ML model 205, an indication of the CSI for the second set of resources (e.g., predicted signal to interference plus noise ratio (SINR) corresponding to future beams 215, slots, and sub-bands). In such cases, the UE 115-a, the network entity 105-a, or both may utilize a set of measurement and prediction resources that may vary in time (e.g., across slots) or spatial resources (e.g., across different beams 215), or frequency (e.g., across different sub-bands). The UE 115-a, the network entity 105-a, or both may utilize one or more CSI prediction algorithms including deep neural networks (e.g., recurrent neural network (RNN), convolution neural network (CNN), transformer, etc.), classical ML models (e.g., support vector machine (SVM), random forest, k-nearest neighbors (KNN), etc.), autoregressive approaches, minimum mean square error (MMSE) predictor approaches, or the like.

In some cases, the network entity 105-a may be unaware of the measurements 210 used as input to a UE-side AI/ML model (e.g., the ML model 205), which may lead to the network entity 105-a determining inaccurate LCM decisions. For example, (e.g., in Type-1 performance monitoring), the network entity 105-a is the node performing the LCM decisions (e.g., model activation, deactivation, fallback and switching). However, the network entity 105-a may be unaware of which ML model configurations led to the reported performance results (e.g., accuracy, MSE, etc.), and the LCM decisions based on the performance results may be inaccurate.

For an illustrative example, the UE 115-a may utilize five previous historical reference signal measurements 210 (e.g., CSI-RS or SSBs) to obtain a top-k beam prediction accuracy of 95%, and the UE 115-a may use 3 measurements 210 as inputs to the ML model (e.g., due to processing ability or power saving), to obtain a top-k beam prediction accuracy performance of 70% (e.g., the top-k beam prediction accuracy performance could drop to 70%). Accordingly, due to the drop in performance, the network entity 105-a may transmit signaling configuring the UE to switch the ML model 205 or fallback to non-ML operation based on assuming that the ML model 205 is not suitable for the environment of the UE, while the drop in performance was caused by the UE 115-a skipping some input reference signal measurements 210 during the monitoring occasion (e.g., which if included would make the inference results more accurate).

Additionally, or alternatively, the network entity 105-a may be unaware of the actual measurements 210 used as input to a UE-side AI/ML model and may transmit additional reference signals associated with increased reference signal overhead and reduced NES. For example, the UE 115-a may skip some input reference signal measurements 210 (e.g., for UE energy saving purposes) which may degrade the ML model performance. Since the network entity 105-a may be unaware of the actual inputs to the ML model 205, the network entity 105-a may reduce an input reference signal periodicity (e.g., transmit denser reference signals in time) based on assuming it may help the UE 115-a improve ML model performance, which may incur higher overhead and reduced NES (e.g., network unawareness of the relationship between the quantity of measurements used as input to the ML model and the obtained performance results may trigger the network to send more references signals).

In some cases, the UE 115-a may utilize a first input to the ML model 205 (e.g., a reference signal received power (RSRP) prediction ML model) including a greater quantity of the measurements 210 compared to a second input to the ML model 205. For example, the UE 115-a may achieve, report, or both, greater performance results of the ML model 205 utilizing the first input compared to utilizing the second input (e.g., based on the first input including more input measurements). The network entity 105-a may be unaware of the reason behind ML model performance degradation, and the network entity 105-a may assume that the ML model 205 is not suitable for the current environment and may transmit signaling configuring the UE 115-a to fallback to non-AI/ML operation, among other examples. In such cases, the UE 115-a may achieve the greater performance using the first input including the greater quantity of the measurements 210 instead of performing non-AI/ML operations. In some cases, the UE 115-a may operate in a first environment (e.g., a slow-varying environment), and the UE 115-a may utilize relatively few measurements to obtain a high CSI, beam, or interference prediction performance, and, in a second environment (e.g., a fast-varying environment) the UE 115-a may utilize a greater quantity of measurements to obtain similar performance.

For an illustrative example, the UE 115-a may obtain the measurements 210 for a set of beams 215-a (e.g., set B beams) including measurements of four beams performed for five consecutive occasions (e.g., historic beam measurements) at 20 millisecond (ms) intervals. Accordingly, the UE 115-a may input the measurements 210 into the ML model 205 to obtain an RSRP prediction value for a set of predicted beams 215-b corresponding to a prediction accuracy of 2 decibels (dB) compared to a measured RSRP value of the set of predicted beams 215-b (e.g., a ground truth RSRP value). Additionally, or alternatively, the UE 115-a may obtain the measurements 210 for the set of beams 215-a (e.g., set B beams) including measurements of three beams performed for three consecutive occasions at 40 ms intervals. The UE 115-a may input the measurements 210 into the ML model 205 to obtain an RSRP prediction value corresponding to a prediction accuracy of 6 dB compared to the measured RSRP value of the set of predicted beams 215-b (e.g., the ground truth RSRP value). In such examples, the greater prediction accuracy discrepancy (e.g., 6 dB) may induce a UE recommendation for model management, among other examples.

The techniques, methods, and devices described herein may support network management of performance monitoring for UE ML models. For example, the UE 115-a and the network entity 105-a may exchange signaling such that the network entity 105-a may be aware of the measurements 210 included by the UE 115-a as inputs to the ML model 205 as part of a beam management prediction procedure 220. Accordingly, the network entity 105-a may accurately determine ML model management procedures or increased reference signaling based on a performance of the ML model 205.

In some implementations, the network entity 105-a may transmit signaling configuring the UE 115-a to comply with a restriction for the measurements 210 inputted to the ML model 205 (e.g., during performance monitoring). In such implementations, the network entity 105-a may output signaling 225 (e.g., RRC, MAC-CE, or DCI) indicating the restriction to the measurements 210 (e.g., a restriction to a set of measurement parameters associated with the beams 215). Accordingly, the network entity 105-a may be aware of the measurements 210 input to the ML model 205 by the UE 115-a in accordance with the restriction, and the network entity 105-a may correspondingly determine LCM decisions in accordance with the restriction and the performance of the ML model 205.

For an illustrative example, the network entity 105-a may transmit the signaling 225 indicating a quantity of beams of the set of beams 215-a and a type of reference signal measurement associated with the set of beams 215-a to include in the measurements 210. Accordingly, the UE 115-a include, within the measurements 210, one or more measurements corresponding to a set of measured beams 230 of the set of beams 215-a, and the UE 115-a may exclude, from the measurements 210, a set of non-measured beams 235 of the set of beams 215-a. In such examples, the UE 115-a may include the set of measured beams 230 and may exclude the set of non-measured beams 235 from the measurements 210 in accordance with the restriction indicated by the signaling 225. The UE 115-a may input the measurements 210 into the ML model 205 and may obtain, as an output of the ML model 205, an indication of a set of predicted beams 240 (e.g., future beams) including a beam for communications 245. The UE 115-a may measure additional beams of the set of predicted beams 240 for performance monitoring. The network entity 105-a may correspondingly determine LCM decisions in accordance with the restriction and the performance of the ML model 205.

In some implementations, the network entity 105-a may transmit signaling configuring the UE 115-a to report one or more parameters of the measurements 210 (e.g., actual measurements) used as inputs to the ML model 205. For example, the UE 115-a may transmit an indication of the one or more parameters when reporting the performance monitoring results, among other examples. In some implementations, the network entity 105-a may transmit signaling 250 (e.g., RRC, MAC-CE, or DCI) indicating a reporting configuration associated with the beam management prediction procedure 220. The UE 115-a may perform the beam management prediction procedure 220 for the set of beams 215-a to obtain the set of predicted beams 215-b, and the UE 115-a may transmit a report 255 (e.g., via RRC, MAC-CE or UCI) indicating the measurements 210 used as inputs to the ML model 205 as part of the beam management prediction procedure 220. Accordingly, the network entity 105-a may be aware of the measurements 210 input to the ML model 205 by the UE 115-a based on receiving the report 255, and the network entity 105-a may correspondingly determine LCM decisions in accordance with the report 255 and the performance of the ML model 205.

For an illustrative example, the UE 115-a may receive the signaling 250 indicating the report format and may perform the beam management prediction procedure 220. The UE 115-a may transmit the report 255 including an indication of the measurements 210, where one or more parameters of the measurements 210 included in the report by the UE 115-a are in accordance with the reporting configuration. For example, the reporting configuration may indicate for the UE 115-a to report a reference signal type associated with the measurements 210, and the UE 115-a may report one or more SSB measurements included in the measurements 210 in accordance with the reporting configuration. The network entity 105-a may correspondingly determine LCM decisions in accordance with the report 255 and the performance of the ML model 205.

In some implementations, the UE 115-a and the network entity 105-a may communicate using the communications 245 based on performing the beam management prediction procedure 220.

In some examples, the techniques described herein may be utilized for one or more UE-side AI/ML models including CSI/interference/beam prediction, and performing CSI prediction (e.g., via the ML model 205) may support the prediction of any of one or more different metrics (e.g., beam, interference, CSI-RS resource indicator (CRI), SSB resource indicator (SSBRI), RSRP, SINR, channel quality indicator (CQI), precoder matrix indicator (PMI), rank indication (RI), modulation and coding scheme (MCS), etc.).

Particular aspects of the subject matter described in this disclosure demonstrate improvements in network performance monitoring of UE ML models. In some examples, by communicating the signaling 225, the signaling 250, or the report 255, indicating the set of measurements utilized by the UE 115-a as inputs to the ML model 205 as part of the beam management prediction procedure 220, the described techniques can be used to relatively improve UE ML model performance while refraining from increasing an overhead (e.g., a signaling or a processing overhead) of the network entity 105-a, the UE 115-a, or both, unnecessarily. For example, the network entity 105-a may refrain from performing model management procedures based on a performance degradation of the ML model 205 due to a quantity of measurements, or a measurement type, input by the UE 115-a, which may reduce overhead (e.g., processing overhead). Additionally, or alternatively, the network entity 105-a may refrain from outputting additional reference signaling based on the degradation of the ML model 205 caused by the UE 115-a including a quantity of reference signals that is less than a quantity of available reference signals, which may relatively reduce overhead (e.g., signaling overhead) and increase NES.

FIG. 3 shows an example of a ML process 300 that supports network performance monitoring of user equipment (UE) machine learning models. that supports network performance monitoring of UE ML models in accordance with one or more aspects of the present disclosure. The ML process 300 may be implemented at a network entity 105, or a UE 115, or both as described with reference to FIGS. 1 and 2.

The ML process 300 may include a ML algorithm 310. As illustrated, the ML algorithm 310 may be an example of a neural network, such as a deep neural network, a feed forward (FF) or deep feed forward (DFF) neural network, a long/short term memory (LSTM) neural network, or any other type of neural network. However, any other ML algorithms may be supported. For example, the ML algorithm 310 may implement a nearest neighbor algorithm, a linear regression algorithm, a Naïve Bayes algorithm, a random forest algorithm, or any other ML algorithm. Furthermore, the ML process 300 may involve supervised learning, unsupervised learning, semi-supervised learning, reinforcement learning, or any combination thereof.

The ML algorithm 310 may include an input layer 315, one or more hidden layers 320, and an output layer 325. In a fully connected neural network with one hidden layer 320, each hidden layer node 335 may receive a value from each input layer node 330 as input, where each input may be weighted. These neural network weights may be based on a cost function that is revised during training of the ML algorithm 310. Similarly, each output layer node 340 may receive a value from each hidden layer node 335 as input, where the inputs are weighted. If post-deployment training (e.g., online training) is supported, memory may be allocated to store errors and/or gradients for reverse matrix multiplication. These errors and/or gradients may support updating the ML algorithm 310 based on output feedback. Training the ML algorithm 310 may support computation of the weights (e.g., connecting the input layer nodes 330 to the hidden layer nodes 335 and the hidden layer nodes 335 to the output layer nodes 340) to map an input pattern to a desired output outcome. This training may result in a device-specific ML algorithm 310 based on the historic application data and data transfer for a specific network entity 105 or UE 115.

In some examples, input values 305 may be sent to the ML algorithm 310 for processing. In some examples, preprocessing may be performed according to a sequence of operations on the input values 305 such that the input values 305 may be in a format that is compatible with the ML algorithm 310. The input values 305 may be converted into a set of k input layer nodes 330 at the input layer 315. In some cases, different measurements may be input at different input layer nodes 330 of the input layer 315. Some input layer nodes 330 may be assigned default values (e.g., values of 0) if the number of input layer nodes 330 exceeds the number of inputs corresponding to the input values 305. As illustrated, the input layer 315 may include three input layer nodes 330-a, 330-b, and 330-c. However, it is to be understood that the input layer 315 may include any number of input layer nodes 330 (e.g., 20 input nodes).

The ML algorithm 310 may convert the input layer 315 to a hidden layer 320 based on a number of input-to-hidden weights between the k input layer nodes 330 and the n hidden layer nodes 335. The ML algorithm 310 may include any number of hidden layers 320 as intermediate steps between the input layer 315 and the output layer 325. Additionally, each hidden layer 320 may include any number of nodes. For example, as illustrated, the hidden layer 320 may include four hidden layer nodes 335-a, 335-b, 335-c, and 335-d. However, it is to be understood that the hidden layer 320 may include any number of hidden layer nodes 335 (e.g., 10 input nodes). In a fully connected neural network, each node in a layer may be based on each node in the previous layer. For example, the value of hidden layer node 335-a may be based on the values of input layer nodes 330-a, 330-b, and 330-c (e.g., with different weights applied to each node value).

The ML algorithm 310 may determine values for the output layer nodes 340 of the output layer 325 following one or more hidden layers 320. For example, the ML algorithm 310 may convert the hidden layer 320 to the output layer 325 based on a number of hidden-to-output weights between the n hidden layer nodes 335 and the m output layer nodes 340. In some cases, n=m. Each output layer node 340 may correspond to a different output value 345 of the ML algorithm 310. As illustrated, the ML algorithm 310 may include three output layer nodes 340-a, 340-b, and 340-c, supporting three different threshold values. However, it is to be understood that the output layer 325 may include any number of output layer nodes 340. In some examples, post-processing may be performed on the output values 345 according to a sequence of operations such that the output values 345 may be in a format that is compatible with reporting the output values 345.

Particular aspects of the subject matter described in this disclosure demonstrate improvements in network performance monitoring of UE ML models. In some examples, by utilizing the ML algorithm 310 for CSI prediction or the like, the UE may predict a beam for communication based on historical measurements, which may enable the UE to communicate via the beam for communication without performing additional CSI measurements to determine the beam, which may decrease overhead associated with the CSI measurements and may decrease energy consumption, among other improvements.

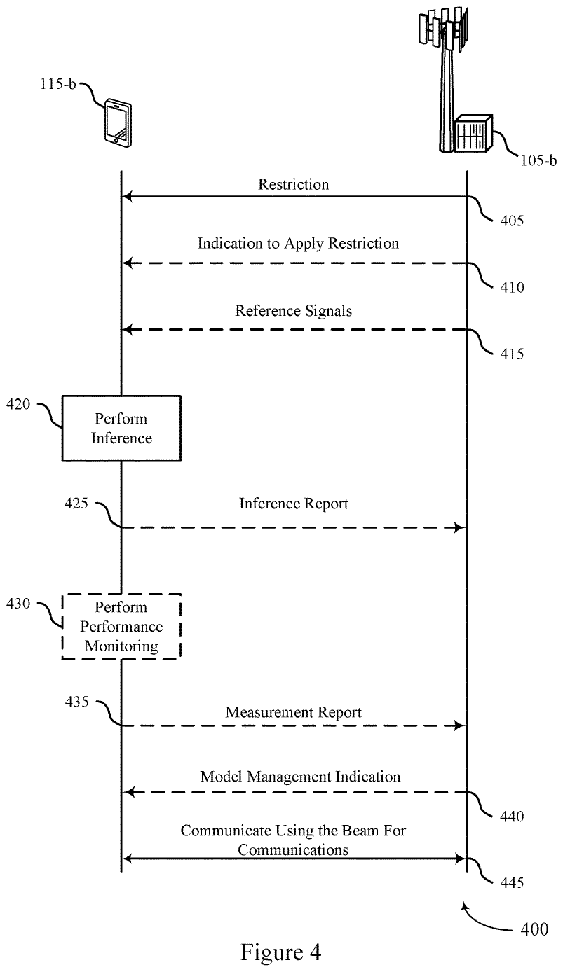

FIG. 4 shows an example of a process flow 400 that supports network performance monitoring of user equipment (UE) machine learning models. that supports network performance monitoring of UE ML models in accordance with one or more aspects of the present disclosure. Aspects of the process flow 400 may implement or be implemented by aspects of the wireless communication system 100, the signaling diagram 200, or both. For example, the process flow 400 may include a UE 115-b, which may be an example of the UE 115 or the UE 115-a, and a network entity 105-b, which may be an example of the network entity 105 or the network entity 105-a.

In the following description of the process flow 400, the operations between the UE 115-b and the network entity 105-b may be performed in different orders or at different times. Some operations may also be left out of the process flow 400, or other operations may be added. Although the UE 115-b and the network entity 105-b are shown performing the operations of the process flow 400, some aspects of some operations may also be performed by one or more other wireless devices.

At 405, the network entity 105-b may transmit, and the UE 115-b may receive, first signaling (e.g., RRC, MAC-CE, or DCI) indicating a restriction of a set of measurement parameters for inclusion in a beam management procedure further described herein with reference to FIG. 2. For example, the network entity 105-b may transmit the first signaling indicating a restriction of a threshold quantity of measurements such that a quantity of measurements (e.g., SSB, CSI-RS, or CSI-IM) input by the UE 115-b to a ML model may satisfy (e.g., be greater than or equal to) the threshold quantity. Additionally, or alternatively, the network entity 105-b may transmit the first signaling indicating a restriction of a time separation between measurements in accordance with a time threshold (e.g., a measurement separation may be less than the time threshold in ms), or a restriction of a measurement resource (e.g., a measurement resource or resource type associated with the measurements may correspond to a specific resource including SSB, CSI-RS, or CSI-IM, etc.), among other examples. For example, the network entity 105-b may indicate a restriction to any parameters associated with the measurements input to the ML model by the UE 115-b.

In some examples, the network entity 105-b may indicate, via the first signaling of 405, a range of values for each indicated restriction. For example, the network entity 105-b may indicate a range of quantities of measurements for the UE 115-b to include as inputs to the ML model, and the UE 115-b may perform one or more measurements and input the measurements into the ML model in accordance with the range (e.g., not exceeding the limits of the range).

In some examples, the network entity 105-b may obtain an indication of how the input measurement parameters affect performance results of the ML model, and the UE 115-b may determine whether to perform LCM decisions (e.g., switch, finetune ML model, fallback to non-ML, etc.), or to determine to increase or decrease reference signal (e.g., SSBs, or CSI-RS) periodicities to increase ML model performance or save energy in accordance with the restriction.

In some examples, at 410, the network entity 105-b may transmit, and the UE 115-b may receive, second signaling (e.g., RRC, MAC-CE, or DCI) indicating whether to apply the restriction indicated by the first signaling of 405. For example, the network entity 105-b may transmit the second signaling indicating whether the UE 115-b may monitor reference signals indicated (e.g., permitted) by the restriction during performance monitoring, or whether the UE 115-b may input measurements of additional reference signals different from the reference signals indicated by the restriction into the ML model during performance monitoring.

In some examples, the network entity 105-b may indicate for the UE 115-b to refrain from (e.g., avoid) including additional measurements different from the measurements indicated by the restriction as inputs to the ML model during performance monitoring. For an example, the network entity 105-b may attempt to determine whether sending CSI-RS with periodicity of 40 ms may allow the UE 115-b to attain accurate performance results (e.g., prediction results using the ML model). In such examples, the UE 115-b may include more measurements (e.g., aperiodic CSI-RS (AP CSI-RS)) as inputs to the ML model, which may improve a prediction performance. However, the network entity 105-b may assume a CSI-RS of periodicity 40 ms is sufficient to attain the prediction performance during inference and may subsequently transmit the CSI-RS according to the 40 ms periodicity, which may result in a degradation of the ML model inference performance. Accordingly, the network entity 105-b may transmit the second signaling configuring the UE 115-b to monitor reference signals indicated by the restriction during performance monitoring or to input additional measurements to the AI/ML model.

In some examples, at 415, the network entity 105-b may transmit a set of reference signals. In some examples, the network entity 105-b may transmit the set of reference signals according to the restriction, or the network entity 105-b may transmit the set of reference signals including reference signals different than the reference signals indicated by the restriction. In some examples, the UE 115-b may perform one or more measurements on the set of reference signals in accordance with the restriction and in accordance with the second signaling of 410 indicating whether to apply the restriction.

In some examples, at 420, the UE 115-b may perform ML model inference according to one or more techniques further described herein with reference to FIG. 2 based on receiving the set of reference signals and performing the one or more measurements (e.g., measurements of a first set of communication resources corresponding to the set of reference signals). The UE 115-b may input the one or more measurements into the ML model and may obtain, as an output of the ML model, an indication of predicted CSI for a second set of communication resources. For example, the indication of predicted CSI may include predictions of one or more communication beams, an interference level, CSI, a SSB resource indicator (SSBRI), a reference signal received power, a signal to interference plus noise value, a CQI value, a precoding matrix indicator, a rank indicator, a modulation and coding scheme, or any combination thereof. For example, the predicted CSI may include an indication of one or more predicted beam metrics associated with a set of predicted beams including a beam for communication (e.g., an identified beam for communication based on the output of the ML model), and the predicted beam metrics may be in accordance with the restriction.

In some examples, at 425, the UE 115-b may transmit an inference report (e.g., via RRC, MAC-CE or UCI). For example, the network entity 105-b may, via the first signaling of 405, configure the UE 115-b with the restriction to the (e.g., a minimum or maximum quantity of) measurements used as inputs to the ML model when the UE 115-b is configured to perform ML model inference, and the UE 115-b may report the inference results (e.g., before performing performance monitoring). Additionally, or alternatively, the network entity 105-b may transmit signaling configuring the UE 115-b to report parameters of ML model inputs (e.g., key input parameters) during inference, and the UE 115-b may report the parameters of the one or more measurements that were input to the ML model via the inference report.

In some examples, at 430, the UE 115-b may perform performance monitoring according to one or more techniques further described herein with reference to FIG. 2. For example, the UE 115-b may perform one or more measurements of the predicted CSI (e.g., predicted beams) indicated by the inference of 420, and the UE 115-b may compare the measurements to the predicted metrics associated with the predicted CSI. In such examples, the UE 115-b may determine (e.g., calculate, or compute) a difference between the measurements and the predicted metrics (e.g., a MSE between the measured and predicted SINR, RSRP, or interference).

In some examples, at 435, the UE 115-b may transmit a measurement report (e.g., via RRC, MAC-CE or UCI) indicating the difference (e.g., metrics of the difference, or a similarity) between the predicted metrics and the measurements, and, at 440, the network entity 105-b may transmit, and the UE 115-b may receive, second signaling indicating one or more ML model management procedures in accordance with the measurement report. For example, the network entity 105-b may transmit the second signaling indicating for the network entity 105-b to switch ML models based on the difference indicated by the measurement report and in accordance with the restriction.

At 445, the UE 115-b and the network entity 105-b may communicate using the predicted CSI (e.g., beam, CQI, SSB, CQI, PMI, RI, MCS) for communication based at least in part on performing the inference of 420, the performance monitoring of 430, or both.

Particular aspects of the subject matter described in this disclosure demonstrate improvements in network performance monitoring of UE ML models. In some examples, by communicating the first signaling indicating the restriction, the described techniques can be used to relatively improve UE ML model performance while refraining from increasing an overhead (e.g., a signaling or a processing overhead) of the network entity 105-b, the UE 115-b, or both, unnecessarily. For example, the network entity 105-b may refrain from performing model management procedures based on a performance degradation of the ML model due to a quantity of measurements, or a measurement type, input by the UE 115-b, which may reduce overhead (e.g., processing overhead). Additionally, or alternatively, the network entity 105-b may refrain from outputting additional reference signaling based on the degradation of the ML model caused by the UE 115-b including a quantity of reference signals that is less than a quantity of available reference signals, which may relatively reduce overhead (e.g., signaling overhead) and increase NES.

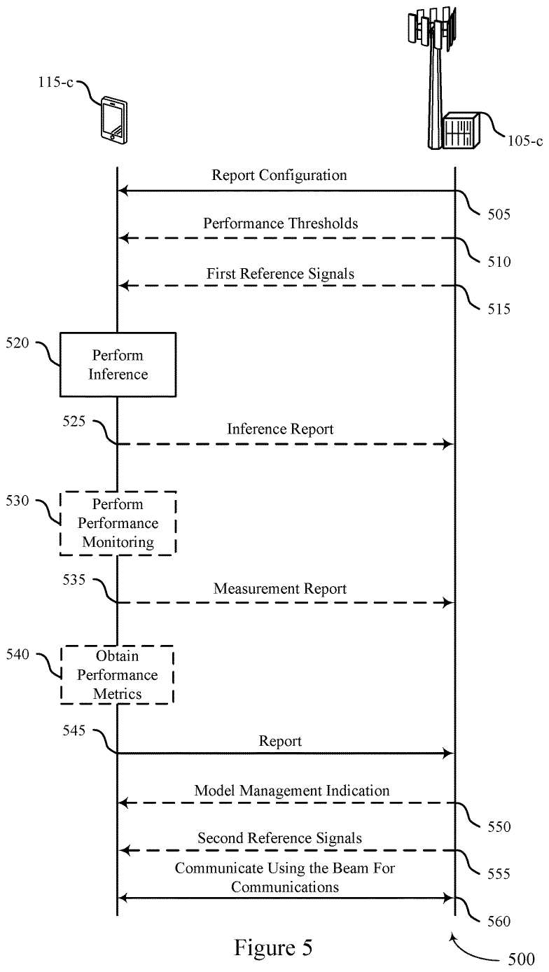

FIG. 5 shows an example of a process flow 500 that supports network performance monitoring of user equipment (UE) machine learning models. that supports network performance monitoring of UE ML models in accordance with one or more aspects of the present disclosure. Aspects of the process flow 500 may implement or be implemented by aspects of the wireless communication system 100, the signaling diagram 200, or both. For example, the process flow 500 may include a UE 115-c, which may be an example of the UE 115 or the UE 115-a, and a network entity 105-c, which may be an example of the network entity 105 or the network entity 105-a.

In the following description of the process flow 500, the operations between the UE 115-c and the network entity 105-c may be performed in different orders or at different times. Some operations may also be left out of the process flow 500, or other operations may be added. Although the UE 115-c and the network entity 105-c are shown performing the operations of the process flow 500, some aspects of some operations may also be performed by one or more other wireless devices.

At 505, the network entity 105-c may transmit, and the UE 115-c may receive, first signaling (e.g., RRC, MAC-CE or DCI) indicating a reporting configuration associated with a beam management prediction procedure further described herein with reference to FIG. 2. For example, the UE 115-c may input one or more measurements into a ML model as part of the beam management prediction procedure. Accordingly, the network entity 105-c may indicate, via the first signaling, one or more parameters associated with the measurements for the UE 115-c to include in a report in accordance with the reporting configuration.

For example, the network entity 105-c may indicate, via the first signaling, one or more time parameters associated with the measurements for the UE 115-c to report, including a quantity of historical measurement occasions (e.g., SSB, CSI-RS, or CSI-IM) utilized as inputs to the ML model, an indication of a time associated with each of the measurements (e.g., a time stamp), or a periodicity (e.g., a time separation) of the historical measurements utilized as inputs to the ML model by the UE 115-c, among other examples.

In some examples, the network entity 105-c may indicate, via the first signaling, one or more beam parameters associated with the measurements for the UE 115-c to report, including a quantity of measured beams (e.g., set B beams) associated with each measurement occasion, a beam identifier (ID) (e.g., a SSBRI, or CRI) associated with the measured beams, or a beam separation (e.g., a spatial separation) between beam measurements used as inputs to the ML model by the UE 115-c, among other examples.

In some examples, the network entity 105-c may indicate, via the first signaling, one or more frequency parameters associated with the measurements for the UE 115-c to report, including an indication of whether a respective measurement corresponds to a wideband measurement or a narrowband measurement, a bandwidth of the measurements, or a frequency separation between measurements used as inputs to the ML model by the UE 115-c.

In some examples, the network entity 105-c may indicate, via the first signaling, a resource type (e.g., a type of input resources) associated with the measurements. For example, the network entity 105-c may indicate for the UE 115-c to report, in accordance with the reporting configuration, a resource type for each measurement (e.g., whether the measurements corresponded to SSB, CSI-RS, or CSI-IM measurements). Additionally, or alternatively, the network entity 105-c may indicate, via the first signaling, for the UE 115-c to report whether one or more measurements were skipped and quantity of measurements skipped during performance monitoring. For example, the network entity 105-c may indicate for the UE 115-c to report whether one or more measurements associated with reference signals output by the network entity 105-c were not included as inputs to the ML model by the UE 115-c.

In some examples, at 510, the network entity 105-c may transmit, and the UE 115-c may receive, second signaling (e.g., RRC, MAC-CE or DCI) configuring the UE 115-c with one or more thresholds on performance monitoring results (e.g., KPIs for performance monitoring including CQI prediction accuracy, or top-k beam prediction accuracy). In such examples, the UE 115-c may (e.g., is triggered to) report actual ML model input parameters used to achieve a ML model performance level based on the performance level satisfying one or more of the thresholds. For example, to assist the network entity 105-c in LCM decisions, the UE 115-c may be triggered to report the parameters of the inputs to the ML model when a performance KPI is a below a threshold during performance monitoring, among other examples.

For an illustrative example, the network entity 105-c may indicate, via the second signaling, a MSE threshold of 4 dB. Accordingly, the UE 115-c may report the input parameters used during the beam management prediction procedure based on a predicted SINR having a MSE greater than 4 dB compared to a measured SINR value. In such examples, the network entity 105-c may configure the threshold that triggers the UE to report the ML model input parameters, or such thresholds may be predefined.

In some examples, at 515, the network entity 105-c may transmit a first set of reference signals, and the UE 115-c may receive the first set of reference signals, perform one or more measurements over a first set of communication resources (e.g., associated with the first set of reference signals), or both.

In some examples, at 520, the UE 115-c may perform ML model inference according to one or more techniques further described herein with reference to FIG. 2 based on receiving the first set of reference signals and performing the one or more measurements. For example, the UE 115-c may input the one or more measurements into the ML model and may obtain, as an output of the ML model, an indication of predicted CSI associated with a second set of communication resources. For example, the predicted CSI may include one or more predicted beam metrics associated with a set of predicted beams including a beam for communication (e.g., an identified beam for communication based on the output of the ML model).

In some examples, at 525, the UE 115-c may transmit an inference report (e.g., via RRC, MAC-CE or UCI). For example, the network entity 105-c may, via the first signaling of 505, configure the UE 115-c to report parameters of ML model inputs (e.g., key input parameters) during inference, and the UE 115-c may report the parameters via the inference report. In some examples, the inference report may include the indication of the predicted CSI.

In some examples, at 530, the UE 115-c may perform performance monitoring according to one or more techniques further described herein with reference to FIG. 2. For example, the UE 115-c may perform one or more measurements of the predicted beams indicated by the inference of 520, and the UE 115-c may compare the measurements to the predicted metrics associated with the predicted beams. In such examples, the UE 115-c may determine (e.g., calculate, or compute) a difference between the measurements and the predicted metrics (e.g., a MSE between the measured and predicted SINR, RSRP, or interference). In some examples, at 535, the UE 115-c may transmit a measurement report (e.g., via RRC, MAC-CE or UCI) indicating the difference (e.g., a difference, or a similarity) between the predicted metrics and the measurements. For example, the UE 115-c may indicate, via the measurement report, an accuracy (e.g., a percentage, or a rate) associated with a comparison between the predicted metrics and the measurements, which may indicate a difference or a similarity (e.g., a percent similarity based on the accuracy) between the predicated metrics and the measurements.

In some examples, at 540, the UE 115-c may obtain one or more metrics associated with communications between the UE 115-c and the network entity 105-c. For example, the UE 115-c may obtain an indication of one or more performance KPIs associated with the communications.

At 545, the UE 115-c may transmit, and the network entity 105-c may receive, a report (e.g., via RRC, MAC-CE or UCI) indicating the one or more measurement parameters associated with the measurements input by the UE 115-c into the ML model, where the report is in accordance with the reporting configuration indicated by the first signaling of 505. In some examples, the UE 115-c may transmit the report as part of the measurement report, the inference report, or both. In some examples, at 550, the network entity 105-c may transmit, and the UE 115-c may receive, second signaling indicating one or more ML model management procedures in accordance with the report of 545. For example, the network entity 105-c may transmit the second signaling indicating for the network entity 105-c to switch ML models based on the difference indicated by the measurement report and in accordance with the parameters indicated by the report of 545.

Additionally, or alternatively, at 555, the network entity 105-c may transmit, and the UE 115-c may receive, a second set of reference signals in accordance with the report of 545. For example, the network entity 105-c may transmit the second set of reference signals according to a decreased periodicity than a periodicity of the first set of reference signals in accordance with the report (e.g., based on the measurement report indicating relatively poor model performance and in accordance with the parameters used during inference), among other examples.

At 560, the UE 115-c and the network entity 105-c may communicate using the beam for communication based at least in part on performing the inference of 520, the performance monitoring of 530, or both.

Particular aspects of the subject matter described in this disclosure demonstrate improvements in network performance monitoring of UE ML models. In some examples, by communicating the first signaling and the report indicating the set of measurements utilized by the UE 115-c as inputs to the ML model as part of the beam management prediction procedure, the described techniques can be used to relatively improve UE ML model performance while refraining from increasing an overhead (e.g., a signaling or a processing overhead) of the network entity 105-c, the UE 115-c, or both, unnecessarily. For example, the network entity 105-c may refrain from performing model management procedures based on a performance degradation of the ML model due to a quantity of measurements, or a measurement type, input by the UE 115-c, which may reduce overhead (e.g., processing overhead). Additionally, or alternatively, the network entity 105-c may refrain from outputting additional reference signaling based on the degradation of the ML model caused by the UE 115-c including a quantity of reference signals that is less than a quantity of available reference signals, which may relatively reduce overhead (e.g., signaling overhead) and increase NES.

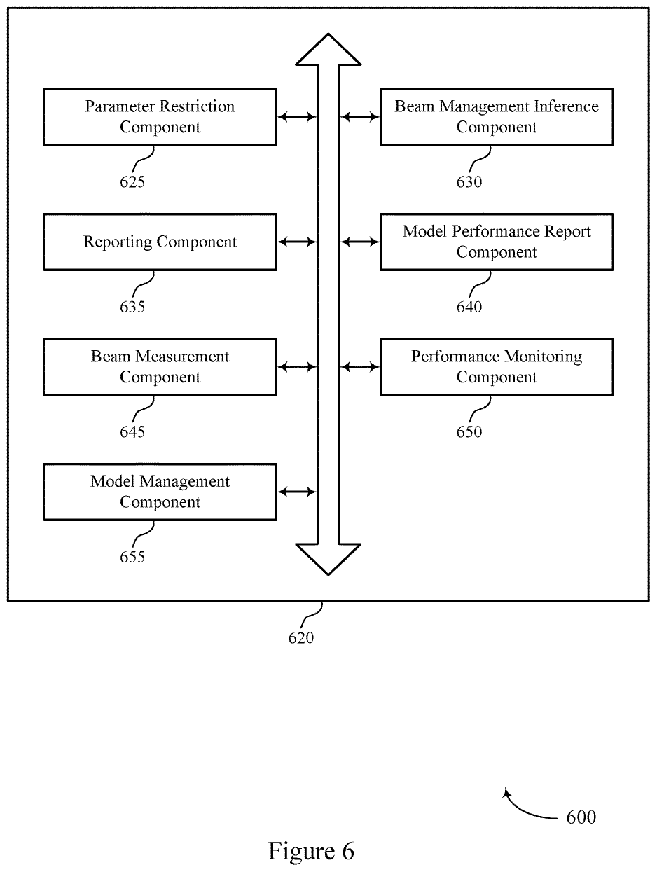

FIG. 6 shows an example 600 of a processing system 620 that supports network performance monitoring of UE ML models. A processing system 620 may be an example of a processing system 140 (such as of a UE 115) and may include a parameter restriction component 625, a beam management inference component 630, reporting component 635, a model performance report component 640, a beam measurement component 645, a performance monitoring component 650, a model management component 655, or any combination thereof. A processing system 620, or various component thereof, may be an example of means for performing (such as a means for causing a UE 115 to perform) various techniques described herein.

The parameter restriction component 625 may be configured to cause the UE 115 to receive first signaling including an indication of a restriction of a set of measurement parameters for inclusion in a CSI prediction procedure. The beam management inference component 630 may be configured to cause the UE 115 to input, into one or more ML models as part of the CSI prediction procedure, a set of multiple measurements corresponding to a first set of multiple communication resources in accordance with the restriction of the set of measurement parameters. In some examples, the beam management inference component 630 may be configured to cause the UE 115 to obtain an indication of a predicted CSI associated with a second set of multiple communication resources in accordance with an output of the one or more ML models based on the set of measurement parameters. The reporting component 635 may be configured to cause the UE 115 to report the indication of the predicted CSI to a network entity.

In some examples, the CSI prediction procedure includes a prediction, via the output of the one or more ML models, of one or more communication beams, an interference level, CSI, a SSBRI, a RSRP, a SINR value, a CQI value, a PMI, a RI, an MCS, or any combination thereof.

In some examples, the model performance report component 640 may be configured to cause the UE 115 to transmit an inference report to a network entity, where the inference report includes the indication of the predicted CSI and an indication of the set of multiple measurements.

In some examples, the beam measurement component 645 may be configured to cause the UE 115 to perform one or more CSI measurements of the second set of multiple communication resources. In some examples, the performance monitoring component 650 may be configured to cause the UE 115 to compare the one or more CSI measurements to the predicted CSI, the predicted CSI in accordance with the CSI prediction procedure. In some examples, the model performance report component 640 may be configured to cause the UE 115 to transmit a measurement report including an indication of a difference, or a similarity, or both between the one or more CSI measurements and the predicted CSI.

In some examples, the model management component 655 may be configured to cause the UE 115 to receive second signaling including an indication of one or more model management procedures in accordance with the measurement report.

In some examples, the difference includes a mean squared error value between the one or more CSI measurements and the predicted CSI.

In some examples, the parameter restriction component 625 may be configured to cause the UE 115 to receive second signaling that indicates whether to apply the restriction of the set of measurement parameters associated with the CSI prediction procedure.

In some examples, the beam management inference component 630 may be configured to cause the UE 115 to input, into the one or more ML models as part of the CSI prediction procedure, an additional set of multiple measurements corresponding to a second set of communication resources different from the set of multiple measurements in accordance with the second signaling, where the second signaling indicates an absence of the restriction of the set of measurement parameters.

In some examples, the beam measurement component 645 may be configured to cause the UE 115 to receive a set of multiple reference signals associated with the first set of multiple communication resources, where the set of multiple reference signals is in accordance with the set of measurement parameters. In some examples, the beam measurement component 645 may be configured to cause the UE 115 to measure the set of multiple reference signals, where the set of multiple measurements included in the CSI prediction procedure is in accordance with the set of multiple reference signals.

In some examples, the restriction of the set of measurement parameters indicates a quantity of beams, or one or more measurement types, or a time separation between measurements, or a quantity of frequency sub-channels, or a frequency separation between one or more measurements of the set of multiple measurements, or any combination thereof for inclusion in the CSI prediction procedure.

In some examples, the one or more measurement types include SSB measurements, or CSI-RS, or CSI-IM, or any combination thereof.

In some examples, the first signaling includes radio resource control signaling, or MAC-CE signaling, or DCI, or any combination thereof.

Additionally, or alternatively, the model performance report component 640 may be configured to cause the UE 115 to receive signaling including an indication of a reporting configuration associated with a CSI prediction procedure. In some examples, the beam management inference component 630 may be configured to cause the UE 115 to input, into one or more ML models as part of the CSI prediction procedure, a set of multiple measurements corresponding to a first set of multiple communication resources. In some examples, the beam management inference component 630 may be configured to cause the UE 115 to obtain an indication of a predicted CSI associated with a second set of multiple communication resources in accordance with an output of the one or more ML models based on the set of multiple measurements. In some examples, the model performance report component 640 may be configured to cause the UE 115 to transmit a report including an indication of the set of multiple measurements in accordance with the reporting configuration.

In some examples, the report includes the indication of the predicted CSI.

In some examples, the beam measurement component 645 may be configured to cause the UE 115 to perform one or more CSI measurements of the second set of multiple communication resources. In some examples, the performance monitoring component 650 may be configured to cause the UE 115 to compare the one or more CSI measurements to the predicted CSI, the predicted CSI in accordance with the CSI prediction procedure. In some examples, the model performance report component 640 may be configured to cause the UE 115 to transmit a measurement report including an indication of a difference between the one or more CSI measurements and the predicted CSI.

In some examples, the model management component 655 may be configured to cause the UE 115 to receive second signaling including an indication of one or more model management procedures associated with the one or more ML models in accordance with the measurement report.

In some examples, the beam measurement component 645 may be configured to cause the UE 115 to receive a set of multiple reference signals associated with the first set of multiple communication resources. In some examples, the beam measurement component 645 may be configured to cause the UE 115 to measure the set of multiple reference signals to obtain the set of multiple measurements, where the report indicates the set of multiple reference signals.

In some examples, the report includes an indication of one or more skipped measurements of a second set of multiple measurements including the set of multiple measurements, the one or more skipped measurements corresponding to one or more reference signals of the set of multiple reference signals.

In some examples, the performance monitoring component 650 may be configured to cause the UE 115 to obtain one or more metrics associated with communications between the UE and a network entity in accordance with the predicted CSI. In some examples, the model performance report component 640 may be configured to cause the UE 115 to transmit the report based on the one or more metrics satisfying one or more performance thresholds.

In some examples, the performance monitoring component 650 may be configured to cause the UE 115 to receive second signaling indicating the one or more performance thresholds.

In some examples, the indication of the set of multiple measurements includes an indication of a quantity of beams included in the CSI prediction procedure, an indication of one or more measurement types corresponding to the set of multiple measurements, an indication of a time separation between each measurement of the set of multiple measurements, an indication of a set of beam identifiers associated with the quantity of beams, an indication of a spatial separation between each beam of the quantity of beams, an indication of one or more frequency resources associated with the quantity of beams, or any combination thereof.

In some examples, the one or more measurement types include SSB measurements, CSI-RS, CSI-IM, or any combination thereof.

A processing system 620 may include or be a component of one or more chips, systems-on-chips (SoCs), chipsets, packages, components, or devices that individually or collectively constitute or include a processing system. A processing system 620 may interface with other components. For example, operations described with reference to the processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a processing system 620).

By including or configuring a processing system 620 for operation in a processing system 620 as described herein, the processing system 620 may support techniques for improved communication reliability, reduced latency, improved user experience related to reduced processing, reduced power consumption, improved coordination between devices, longer battery life, improved utilization of processing capability, among other improvements.

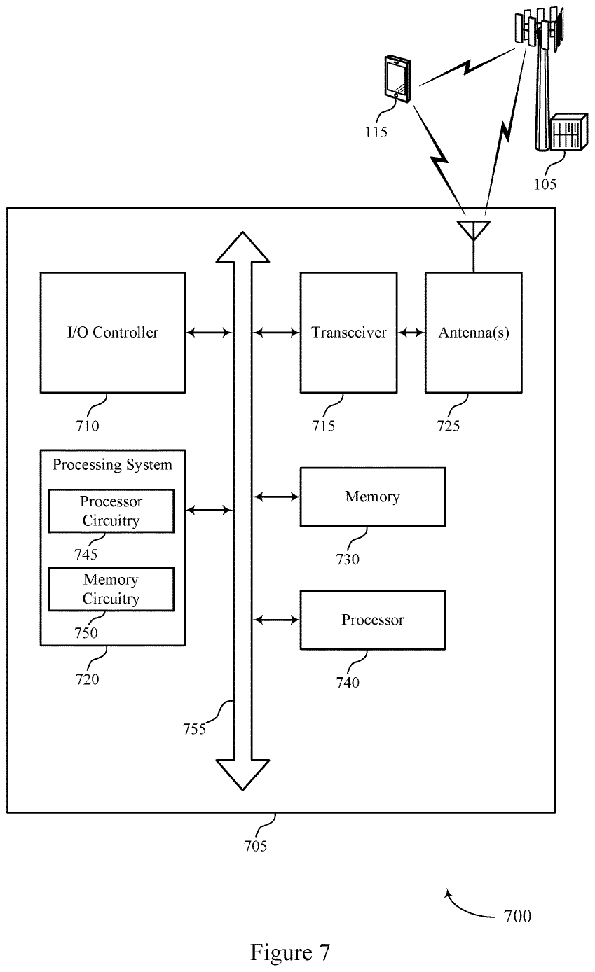

FIG. 7 shows an example of a system 700 including a device 705 that supports network performance monitoring of UE ML models. The device 705 may be an example of or include components of UE 115. The device 705 may communicate (such as wirelessly) with one or more other devices (such as network entities 105, UEs 115). The device 705 may include components for transmitting and receiving communication, which may include a processing system 720, an input/output (I/O) controller, such as an I/O controller 710, a transceiver 715, antenna(s) 725, a memory 730, and a processor 740. Components of the device 705 may be coupled (such as operatively, communicatively, functionally, electronically, electrically, in electronic communication) a bus 755.

The transceiver 715 may support bi-directional communication via antenna(s) 725, and may support transmission operations, reception operations, or both, as described herein. The transceiver 715 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 705). The transceiver 715 may modulate symbols and provide the modulated symbols to antenna(s) 725 for transmission, and demodulate symbols from signals received using antenna(s) 725.

The processor 740 may be a general-purpose processing component that supports various operations (such as applications) of the device 705. The memory 730 may be a general-purpose storage component that stores code executable by the processor 740. Such code may include instructions that, when executed by the processor 740, cause the device 705 to perform various functions (such as to support an application of the device 705). The I/O controller 710 may manage inputs and outputs for the device 705, may manage peripherals not integrated into the device 705, or may represent a physical connection (such as port) to an external peripheral. The processor 740 may interact with a modem, a keyboard, a mouse, a touchscreen, or other device (such as via I/O controller 710). In some implementations, a user may interact with the device 705 via the I/O controller 710 or via hardware components controlled by the I/O controller 710.

The processing system 720 may be an example of a processing system 140 or a processing system 620. For example, the processing system 720 may include processor circuitry 745 and memory circuitry 750 that stores code, and may be configured to cause the device 705 to perform operations that support network performance monitoring of UE ML models. Although the processing system 720 is illustrated as a separate component, which may involve a separate chip, chipset, or other module, in some implementations, one or more functions described with reference to the processing system 720 may be supported by or performed by a transceiver 715, antenna(s) 725, a processor 740, memory 730, or any combination thereof, such that a processing system 720 may include one or more of a transceiver 715, antenna(s) 725, a processor 740, memory 730, or any combination thereof.

By including or configuring the processing system 720 for operation in the device 705 as described herein, may support techniques for improved communication reliability, reduced latency, improved user experience related to reduced processing, reduced power consumption, improved coordination between devices, longer battery life, and improved utilization of processing capability, among other improvements.

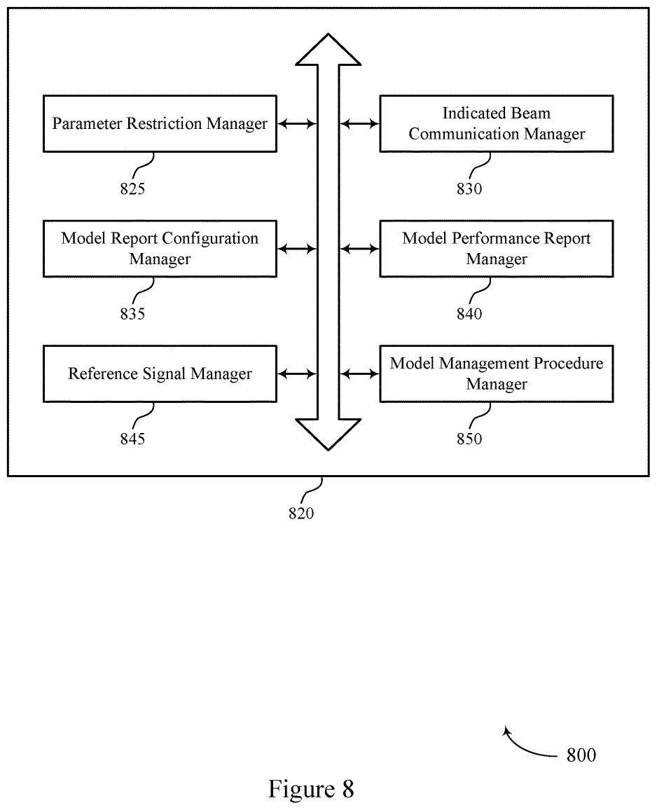

FIG. 8 shows an example 800 of a processing system 820 that supports network performance monitoring of UE ML models. A processing system 820 may be an example of a processing system 145 (such as network entity 105) and may include a parameter restriction manager 825, an indicated beam communication manager 830, a model reporting configuration manager 835, a model performance report manager 840, a reference signal manager 845, a model management procedure manager 850, or any combination thereof. A processing system 820, or various component thereof, may be an example of means for performing (such as a means for causing a network entity 105 to perform) various techniques described herein.

The parameter restriction manager 825 may be configured to cause the network entity 105 to output first signal including an indication of a restriction of a set of measurement parameters for inclusion in a CSI prediction procedure at a UE (e.g., the restriction to be applied by the UE for the CSI prediction procedure). The indicated beam communication manager 830 may be configured to cause the network entity 105 to obtain a report from the UE including an indication of a predicted CSI of a set of multiple communication resources in accordance with the CSI prediction procedure and the restriction of the set of measurement parameters.

In some examples, the report includes an indication of a subset of the set of measurement parameters included in the CSI prediction procedure used to obtain the predicted CSI.

In some examples, the model performance report manager 840 may be configured to cause the network entity 105 to obtain a measurement report including an indication of a difference between one or more CSI measurements of the set of multiple communication resources and the predicted CSI, the predicted CSI based on the CSI prediction procedure at the UE.

In some examples, the model management procedure manager 850 may be configured to cause the network entity 105 to output second signal indicating whether to apply the restriction of the set of measurement parameters associated with the CSI prediction procedure.

Additionally, or alternatively, the model reporting configuration manager 835 may be configured to cause the network entity 105 to output first signal including an indication of a reporting configuration associated with a CSI prediction procedure at a UE. In some examples, the model reporting configuration manager 835 may be configured to cause the network entity 105 to obtain, in accordance with the reporting configuration, a report including an indication of a set of measurements that were used as input to the CSI prediction procedure to obtain predicted CSI for a set of multiple communication resources.

In some examples, the report includes an indication of the predicted CSI.

In some examples, the model performance report manager 840 may be configured to cause the network entity 105 to obtain a measurement report including an indication of a difference between one or more CSI measurements of the set of multiple communication resources and the predicted CSI, the predicted CSI based on the CSI prediction procedure at the UE.

In some examples, the reference signal manager 845 may be configured to cause the network entity 105 to output a first set of multiple reference signals, where the set of measurements associated with the CSI prediction procedure are in accordance with the first set of multiple reference signals. In some examples, the reference signal manager 845 may be configured to cause the network entity 105 to output a second set of multiple reference signals based on the report.

A processing system 820 may include or be an example of one or more chips, SoCs, chipsets, packages, components, or devices that individually or collectively constitute or include a processing system. A processing system 820 may interface with other components of a network entity 105. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a network entity 105). Operations described herein with reference to the processing system 820, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 820 for operation in a processing system 820 as described herein, the processing system 820 may support techniques for improved communication reliability, reduced latency, improved user experience related to reduced processing, reduced power consumption, improved coordination between devices, longer battery life, and improved utilization of processing capability, among other improvements.

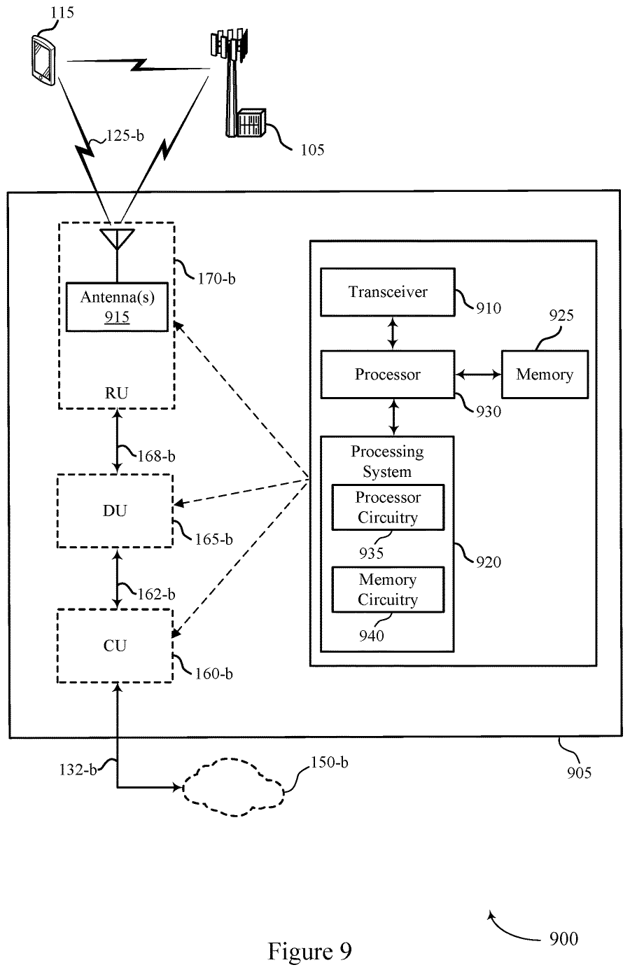

FIG. 9 shows an example of a system 900 including a device 905 that supports network performance monitoring of UE ML models. The device 905 may communicate (such as via one or more wired interfaces or one or more wireless interfaces) with other network devices or network equipment such as a core network 150-b, other network entities 105, UEs 115, or any combination thereof. The device 905 may include components for transmitting and receiving communication, which may include a processing system 920, a transceiver 910, antenna(s) 915, a memory 925, and a processor 930. Components of the device 905 may be coupled (such as operatively, communicatively, functionally, electronically, electrically, in electronic communication) via one or more interfaces.

The transceiver 910 may communicate bi-directionally with another transceiver via wired or wireless links, and may support transmission operations, reception operations, or both, as described herein. The transceiver 910 may include a modem to modulate and demodulate signals, to provide the modulated signals for transmission (such as via antenna(s) 915, via a wired interface), and to demodulate received signals (such as received via antenna(s) 915, received via a wired interface). The transceiver 910 may be operable to support communication via one or more communication links (such as a communication link 125-b, a backhaul link 132-b, a midhaul link 162-b, fronthaul link 168-b).

The processor 930 may be a general-purpose processing component that supports various operations (such as applications) of the device 905. The memory 925 may be a general-purpose storage component that stores code executable by the processor 930. Such code may include instructions that, when executed by the processor 930, cause the device 905 to perform various functions (such as to support an application of the device 905).

For examples in which the device 905 is a network entity 105 in a disaggregated architecture, one or more components of the device 905 may be located at one or more of a CU 160-b, a DU 165-b, or an RU 170-b, one or more of which may include aspects of the processing system 920, the processor 930, the memory 925, or the transceiver 910. Functions of the device 905 may be performed at different components or an operation may be divided between different components (such as different functions being supported by aspects of the CU 160-b, the DU 165-b, or the RU 170-b, the transceiver 910, the processor 930, the memory 925, the processing system 920, or any combination thereof). For example, the processing system 920 may be a component of one or more of the CU 160-b, the DU 165-b, or the RU 170-b. In some examples, interfaces between components of device 905 (such as CU 160-b, DU 165-b, RU 170-b) may support communication at a protocol layer or between protocol layers of a protocol stack.

In some examples, the processing system 920 may manage aspects of communication with the core network 150-b (such as via a backhaul link 132). For example, the processing system 920 may manage the transfer of data communication for UEs 115 with a gateway of the core network 150-b. In some examples, the processing system 920 may manage communication with one or more other network entities 105 and may include a controller or scheduler for controlling communication with UEs 115 (such as in cooperation with the one or more other network entities 105). In some examples, the processing system 920 may support an interface (such as X2 interface, Xn interface) to provide communication between network entities 105.

The processing system 920 may be an example of a processing system 145 or a processing system 820. For example, the processing system 920 may include processor circuitry 935 and memory circuitry 940 that stores code, and the processing system 920 may be configured to cause the device 905 to perform operations that support network performance monitoring of UE ML models. Although the processing system 920 is illustrated as a separate component, which may involve a separate chip, chipset, or other module, in some implementations, one or more functions described with reference to the processing system 920 may be supported by or performed by a transceiver 910, antenna(s) 915, a processor 930, memory 925, or any combination thereof, such that a processing system 920 may include one or more of a transceiver 910, antenna(s) 915, a processor 930, memory 925, or any combination thereof. Further, processor circuitry 935 and memory circuitry 940 each may be implemented at the device 905 in accordance with an aggregated architecture, or the processor circuitry 935 and the memory circuitry 940 may be implemented at one or more of a CU 160-b, a DU 165-b, or an RU 170-b in accordance with a disaggregated architecture.

By including or configuring the processing system 920 for operation in the device 905 as described herein, may support techniques for improved communication reliability, reduced latency, improved user experience related to reduced processing, reduced power consumption, improved coordination between devices, longer battery life, and improved utilization of processing capability, among other improvements.

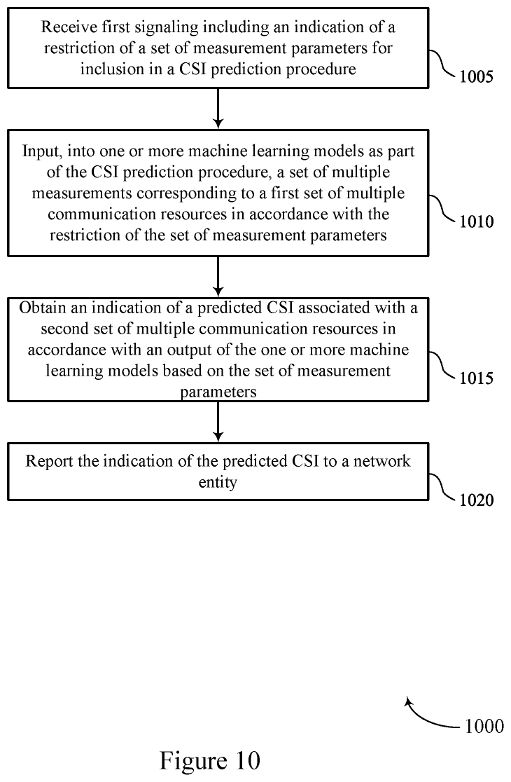

FIG. 10 shows an example of a method 1000 that supports network performance monitoring of UE ML models. Operations of the method 1000 may be performed by a UE or its components (such as using a processing system configured to cause the UE 115 to perform one or more of the operations) as described herein.

At 1005, the method may include receiving first signaling including an indication of a restriction of a set of measurement parameters for inclusion in a CSI prediction procedure. In some examples, aspects of the operations of 1005 may be performed by a parameter restriction component 625.

At 1010, the method may include inputting, into one or more ML models as part of the CSI prediction procedure, a set of multiple measurements corresponding to a first set of multiple communication resources in accordance with the restriction of the set of measurement parameters. In some examples, aspects of the operations of 1010 may be performed by a beam management inference component 630.

At 1015, the method may include obtaining an indication of a predicted CSI associated with a second set of multiple communication resources in accordance with an output of the one or more ML models based on the set of measurement parameters. In some examples, aspects of the operations of 1015 may be performed by a beam management inference component 630.

At 1020, the method may include reporting the indication of the predicted CSI to a network entity. In some examples, aspects of the operations of 1020 may be performed by the reporting component 635.

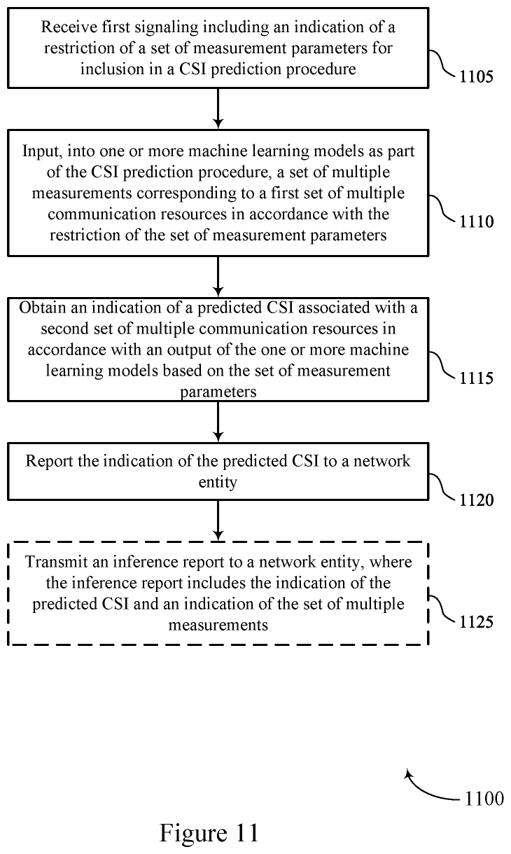

FIG. 11 shows an example of a method 1100 that supports network performance monitoring of UE ML models. Operations of the method 1100 may be performed by a UE or its components (such as using a processing system configured to cause the UE 115 to perform one or more of the operations) as described herein.

At 1105, the method may include receiving first signaling including an indication of a restriction of a set of measurement parameters for inclusion in a CSI prediction procedure. In some examples, aspects of the operations of 1105 may be performed by a parameter restriction component 625.

At 1110, the method may include inputting, into one or more ML models as part of the CSI prediction procedure, a set of multiple measurements corresponding to a first set of multiple communication resources in accordance with the restriction of the set of measurement parameters. In some examples, aspects of the operations of 1110 may be performed by a beam management inference component 630.

At 1115, the method may include obtaining an indication of a predicted CSI associated with a second set of multiple communication resources in accordance with an output of the one or more ML models based on the set of measurement parameters. In some examples, aspects of the operations of 1115 may be performed by a beam management inference component 630.

At 1120, the method may include reporting the indication of the predicted CSI to a network entity. In some examples, aspects of the operations of 1120 may be performed by the reporting component 635.

At 1125, the method may include transmitting an inference report to a network entity, where the inference report includes the indication of the predicted CSI and an indication of the set of multiple measurements. In some examples, aspects of the operations of 1125 may be performed by a model performance report component 640.

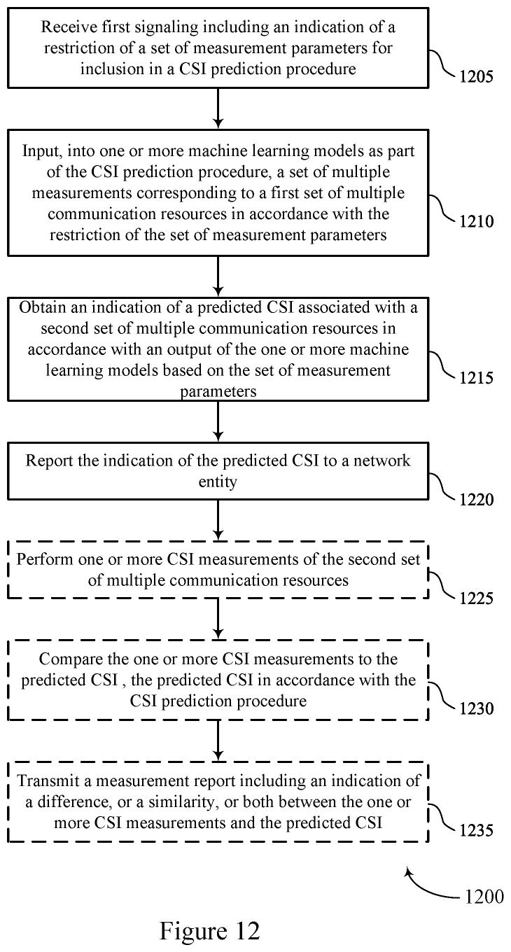

FIG. 12 shows an example of a method 1200 that supports network performance monitoring of UE ML models. Operations of the method 1200 may be performed by a UE or its components (such as using a processing system configured to cause the UE 115 to perform one or more of the operations) as described herein.

At 1205, the method may include receiving first signaling including an indication of a restriction of a set of measurement parameters for inclusion in a CSI prediction procedure. In some examples, aspects of the operations of 1205 may be performed by a parameter restriction component 625.

At 1210, the method may include inputting, into one or more ML models as part of the CSI prediction procedure, a set of multiple measurements corresponding to a first set of multiple communication resources in accordance with the restriction of the set of measurement parameters. In some examples, aspects of the operations of 1210 may be performed by a beam management inference component 630.

At 1215, the method may include obtaining an indication of a predicted CSI associated with a second set of multiple communication resources in accordance with an output of the one or more ML models based on the set of measurement parameters. In some examples, aspects of the operations of 1215 may be performed by a beam management inference component 630.

At 1220, the method may include reporting the indication of the predicted CSI to a network entity. In some examples, aspects of the operations of 1220 may be performed by the reporting component 635.

At 1225, the method may include performing one or more CSI measurements of the second set of multiple communication resources. In some examples, aspects of the operations of 1225 may be performed by a beam measurement component 645.

At 1230, the method may include comparing the one or more CSI measurements to the predicted CSI, the predicted CSI in accordance with the CSI prediction procedure. In some examples, aspects of the operations of 1230 may be performed by a performance monitoring component 650.

At 1235, the method may include transmitting a measurement report including an indication of a difference, or a similarity, or both between the one or more CSI measurements and the predicted CSI. In some examples, aspects of the operations of 1235 may be performed by a model performance report component 640.

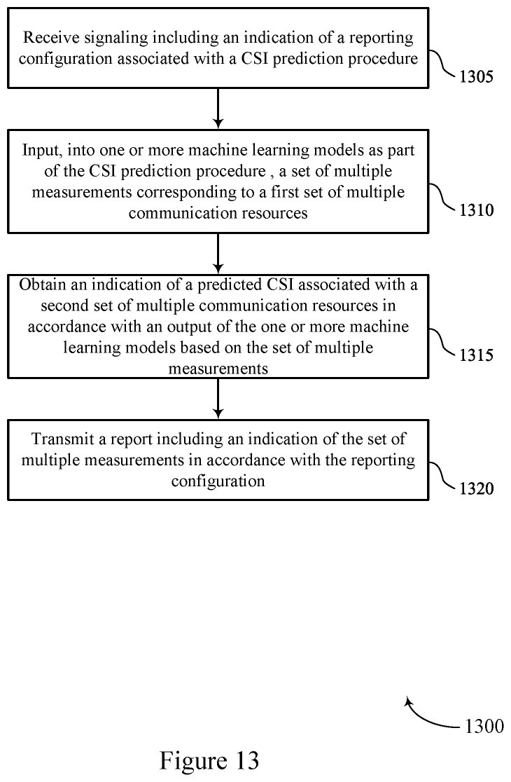

FIG. 13 shows an example of a method 1300 that supports network performance monitoring of UE ML models. Operations of the method 1300 may be performed by a UE or its components (such as using a processing system configured to cause the UE 115 to perform one or more of the operations) as described herein.

At 1305, the method may include receiving signaling including an indication of a reporting configuration associated with a CSI prediction procedure. In some examples, aspects of the operations of 1305 may be performed by a model performance report component 640.

At 1310, the method may include inputting, into one or more ML models as part of the CSI prediction procedure, a set of multiple measurements corresponding to a first set of multiple communication resources. In some examples, aspects of the operations of 1310 may be performed by a beam management inference component 630.

At 1315, the method may include obtaining an indication of a predicted CSI associated with a second set of multiple communication resources in accordance with an output of the one or more ML models based on the set of multiple measurements. In some examples, aspects of the operations of 1315 may be performed by a beam management inference component 630.

At 1320, the method may include transmitting a report including an indication of the set of multiple measurements in accordance with the reporting configuration. In some examples, aspects of the operations of 1320 may be performed by a model performance report component 640.

Implementation examples are described in the following numbered clauses:

Aspect 1: A method for wireless communications at a UE, comprising: receiving first signaling comprising an indication of a restriction of a set of measurement parameters for inclusion in a CSI prediction procedure; inputting, into one or more ML models as part of the CSI prediction procedure, a plurality of measurements corresponding to a first plurality of communication resources in accordance with the restriction of the set of measurement parameters; obtaining an indication of a predicted CSI associated with a second plurality of communication resources in accordance with an output of the one or more ML models based at least in part on the set of measurement parameters; and reporting the indication of the predicted CSI to a network entity.

Aspect 2: The method of aspect 1, wherein the CSI prediction procedure includes a prediction, via the output of the one or more ML models, of one or more communication beams, an interference level, CSI, a SSBRI, a RSRP, a SINR value, a CQI value, a PMI, a rank indicator, a MCS, or any combination thereof.

Aspect 3: The method of any of aspects 1 through 2, further comprising: transmitting an inference report to a network entity, wherein the inference report comprises the indication of the predicted CSI and an indication of the plurality of measurements.

Aspect 4: The method of any of aspects 1 through 3, further comprising: performing one or more CSI measurements of the second plurality of communication resources; comparing the one or more CSI measurements to the predicted CSI, the predicted CSI in accordance with the CSI prediction procedure; and transmitting a measurement report comprising an indication of a difference, or a similarity, or both between the one or more CSI measurements and the predicted CSI.

Aspect 5: The method of aspect 4, further comprising: receiving second signaling including an indication of one or more model management procedures in accordance with the measurement report.

Aspect 6: The method of any of aspects 4 through 5, wherein the difference comprises a mean squared error value between the one or more CSI measurements and the predicted CSI.

Aspect 7: The method of any of aspects 4 through 6, further comprising: receiving second signaling that indicates whether to apply the restriction of the set of measurement parameters associated with the CSI prediction procedure.

Aspect 8: The method of aspect 7, further comprising: inputting, into the one or more ML models as part of the CSI prediction procedure, an additional plurality of measurements corresponding to a second set of communication resources different from the plurality of measurements in accordance with the second signaling, wherein the second signaling indicates an absence of the restriction of the set of measurement parameters.

Aspect 9: The method of any of aspects 1 through 8, further comprising: receiving a plurality of reference signals associated with the first plurality of communication resources, wherein the plurality of reference signals is in accordance with the set of measurement parameters; and measuring the plurality of reference signals, wherein the plurality of measurements included in the CSI prediction procedure is in accordance with the plurality of reference signals.

Aspect 10: The method of any of aspects 1 through 9, wherein the restriction of the set of measurement parameters indicates a quantity of beams, or one or more measurement types, or a time separation between measurements, or a quantity of frequency sub-channels, or a frequency separation between one or more measurements of the plurality of measurements, or any combination thereof for inclusion in the CSI prediction procedure.

Aspect 11: The method of aspect 10, wherein the one or more measurement types include SSB measurements, or CSI-RS, or CSI-IM, or any combination thereof.

Aspect 12: The method of any of aspects 1 through 11, wherein the first signaling comprises radio resource control signaling, or MAC-CE signaling, or DCI, or any combination thereof.

Aspect 13: A method for wireless communications at a UE, comprising: receiving signaling comprising an indication of a reporting configuration associated with a CSI prediction procedure; inputting, into one or more ML models as part of the CSI prediction procedure, a plurality of measurements corresponding to a first plurality of communication resources; obtaining an indication of a predicted CSI associated with a second plurality of communication resources in accordance with an output of the one or more ML models based at least in part on the plurality of measurements; and transmitting a report comprising an indication of the plurality of measurements in accordance with the reporting configuration.

Aspect 14: The method of aspect 13, wherein the report comprises the indication of the predicted CSI.

Aspect 15: The method of any of aspects 13 through 14, further comprising: performing one or more CSI measurements of the second plurality of communication resources; comparing the one or more CSI measurements to the predicted CSI, the predicted CSI in accordance with the CSI prediction procedure; and transmitting a measurement report comprising an indication of a difference between the one or more CSI measurements and the predicted CSI.

Aspect 16: The method of aspect 15, further comprising: receiving second signaling including an indication of one or more model management procedures associated with the one or more ML models in accordance with the measurement report.

Aspect 17: The method of any of aspects 13 through 16, further comprising: receiving a plurality of reference signals associated with the first plurality of communication resources; and measuring the plurality of reference signals to obtain the plurality of measurements, wherein the report indicates the plurality of reference signals.

Aspect 18: The method of aspect 17, wherein the report includes an indication of one or more skipped measurements of a second plurality of measurements comprising the plurality of measurements, the one or more skipped measurements corresponding to one or more reference signals of the plurality of reference signals.

Aspect 19: The method of any of aspects 13 through 18, further comprising: obtaining one or more metrics associated with communications between the UE and a network entity in accordance with the predicted CSI; and transmitting the report based at least in part on the one or more metrics satisfying one or more performance thresholds.

Aspect 20: The method of aspect 19, further comprising: receiving second signaling indicating the one or more performance thresholds.

Aspect 21: The method of any of aspects 13 through 20, wherein the indication of the plurality of measurements includes an indication of a quantity of beams included in the CSI prediction procedure, an indication of one or more measurement types corresponding to the plurality of measurements, an indication of a time separation between each measurement of the plurality of measurements, an indication of a set of beam identifiers associated with the quantity of beams, an indication of a spatial separation between each beam of the quantity of beams, an indication of one or more frequency resources associated with the quantity of beams, or any combination thereof.

Aspect 22: The method of aspect 21, wherein the one or more measurement types include SSB measurements, CSI-RS, CSI-IM, or any combination thereof.

Aspect 23: A method for wireless communication at a network entity, comprising: output first signaling comprising an indication of a restriction of a set of measurement parameters for inclusion in a CSI prediction procedure at a UE; and obtaining a report from the UE comprising an indication of a predicted CSI of a plurality of communication resources in accordance with the CSI prediction procedure and the restriction of the set of measurement parameters.

Aspect 24: The method of aspect 23, wherein the report comprises an indication of a subset of the set of measurement parameters included in the CSI prediction procedure used to obtain the predicted CSI.

Aspect 25: The method of any of aspects 23 through 24, further comprising: obtaining a measurement report comprising an indication of a difference between one or more CSI measurements of the plurality of communication resources and the predicted CSI, the predicted CSI based at least in part on the CSI prediction procedure at the UE.

Aspect 26: The method of aspect 25, further comprising: output second signaling indicating whether to apply the restriction of the set of measurement parameters associated with the CSI prediction procedure.

Aspect 27: A method for wireless communication at a network entity, comprising: output first signaling comprising an indication of a reporting configuration associated with a CSI prediction procedure at a UE; and obtaining, in accordance with the reporting configuration, a report including an indication of a set of measurements that were used as input to the CSI prediction procedure to obtain predicted CSI for a plurality of communication resources.

Aspect 28: The method of aspect 27, wherein the report comprises an indication of the predicted CSI.

Aspect 29: The method of any of aspects 27 through 28, further comprising: obtaining a measurement report comprising an indication of a difference between one or more CSI measurements of the plurality of communication resources and the predicted CSI, the predicted CSI based at least in part on the CSI prediction procedure at the UE.

Aspect 30: The method of any of aspects 27 through 29, further comprising: outputting a first plurality of reference signals, wherein the set of measurements associated with the CSI prediction procedure are in accordance with the first plurality of reference signals; and outputting a second plurality of reference signals based at least in part on the report.

Aspect 31: A UE for wireless communications, comprising a processing system that includes processor circuitry and memory circuitry that stores code, the processing system configured to cause the UE to perform a method of any of aspects 1 through 12.

Aspect 32: A UE for wireless communications, comprising at least one means for performing a method of any of aspects 1 through 12.

Aspect 33: A non-transitory computer-readable medium storing code for wireless communications, the code comprising instructions executable by one or more processors to perform a method of any of aspects 1 through 12.

Aspect 34: A UE for wireless communications, comprising a processing system that includes processor circuitry and memory circuitry that stores code, the processing system configured to cause the UE to perform a method of any of aspects 13 through 22.

Aspect 35: A UE for wireless communications, comprising at least one means for performing a method of any of aspects 13 through 22.

Aspect 36: A non-transitory computer-readable medium storing code for wireless communications, the code comprising instructions executable by one or more processors to perform a method of any of aspects 13 through 22.

Aspect 37: A network entity for wireless communication, comprising a processing system that includes processor circuitry and memory circuitry that stores code, the processing system configured to cause the network entity to perform a method of any of aspects 23 through 26.

Aspect 38: A network entity for wireless communication, comprising at least one means for performing a method of any of aspects 23 through 26.

Aspect 39: A non-transitory computer-readable medium storing code for wireless communication, the code comprising instructions executable by one or more processors to perform a method of any of aspects 23 through 26.

Aspect 40: A network entity for wireless communication, comprising a processing system that includes processor circuitry and memory circuitry that stores code, the processing system configured to cause the network entity to perform a method of any of aspects 27 through 30.

Aspect 41: A network entity for wireless communication, comprising at least one means for performing a method of any of aspects 27 through 30.

Aspect 42: A non-transitory computer-readable medium storing code for wireless communication, the code comprising instructions executable by one or more processors to perform a method of any of aspects 27 through 30.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more memories storing processor-executable code; and
one or more processors coupled with the one or more memories and configured to cause the UE to:
receive first signaling comprising an indication of a restriction of a set of measurement parameters for inclusion in a channel state information (CSI) prediction procedure;
input, into one or more machine learning models as part of the CSI prediction procedure, a plurality of measurements corresponding to a first plurality of communication resources in accordance with the restriction of the set of measurement parameters;
obtain an indication of a predicted CSI associated with a second plurality of communication resources in accordance with an output of the one or more machine learning models based at least in part on the set of measurement parameters; and
report the indication of the predicted CSI to a network entity.

2. The apparatus of claim 1, wherein the CSI prediction procedure includes a prediction, via the output of the one or more machine learning models, of one or more communication beams, an interference level, CSI, a synchronization signal block resource indicator, a reference signal received power, a signal to interference plus noise value, a channel quality indicator value, a precoding matrix indicator, a rank indicator, a modulation and coding scheme, or any combination thereof.

3. The apparatus of claim 1, wherein the one or more processors are configured to cause the UE to:
transmit an inference report to the network entity, wherein the inference report comprises the indication of the predicted CSI and an indication of the plurality of measurements.

4. The apparatus of claim 1, wherein the one or more processors are configured to cause the UE to:
perform one or more CSI measurements of the second plurality of communication resources;
compare the one or more CSI measurements to the predicted CSI, the predicted CSI in accordance with the CSI prediction procedure; and
transmit a measurement report comprising an indication of a difference, or a similarity, or both between the one or more CSI measurements and the predicted CSI.

5. The apparatus of claim 4, wherein the one or more processors are further configured to cause the UE to:
receive second signaling including an indication of one or more model management procedures in accordance with the measurement report.

6. The apparatus of claim 4, wherein the difference comprises a mean squared error value between the one or more CSI measurements and the predicted CSI.

7. The apparatus of claim 4, wherein the one or more processors are further configured to cause the UE to:
receive second signaling that indicates whether to apply the restriction of the set of measurement parameters associated with the CSI prediction procedure.

8. The apparatus of claim 7, wherein the one or more processors are further configured to cause the UE to:
input, into the one or more machine learning models as part of the CSI prediction procedure, an additional plurality of measurements corresponding to a second set of communication resources different from the plurality of measurements in accordance with the second signaling, wherein the second signaling indicates an absence of the restriction of the set of measurement parameters.

9. The apparatus of claim 1, wherein the one or more processors are further configured to cause the UE to:
receive a plurality of reference signals associated with the first plurality of communication resources, wherein the plurality of reference signals is in accordance with the set of measurement parameters; and
measure the plurality of reference signals, wherein the plurality of measurements included in the CSI prediction procedure is in accordance with the plurality of reference signals.

10. The apparatus of claim 1, wherein the restriction of the set of measurement parameters indicates a quantity of beams, or one or more measurement types, or a time separation between measurements, or a quantity of frequency sub-channels, or a frequency separation between one or more measurements of the plurality of measurements, or any combination thereof for inclusion in the CSI prediction procedure.

11. The apparatus of claim 1, wherein the first signaling comprises radio resource control signaling, or medium access control control element (MAC-CE) signaling, or downlink control information, or any combination thereof.

12. An apparatus for wireless communications at a user equipment (UE), comprising:
one or more memories storing processor-executable code; and
one or more processors coupled with the one or more memories and configured to cause the UE to:
receive signaling comprising an indication of a reporting configuration associated with a channel state information (CSI) prediction procedure;
input, into one or more machine learning models as part of the CSI prediction procedure, a plurality of measurements corresponding to a first plurality of communication resources;
obtain an indication of a predicted CSI associated with a second plurality of communication resources in accordance with an output of the one or more machine learning models based at least in part on the plurality of measurements; and
transmit a report comprising an indication of the plurality of measurements in accordance with the reporting configuration.

13. The apparatus of claim 12, wherein the report comprises the indication of the predicted CSI.

14. The apparatus of claim 12, wherein the one or more processors are further configured to cause the UE to:
perform one or more CSI measurements of the second plurality of communication resources;
compare the one or more CSI measurements to the predicted CSI, the predicted CSI in accordance with the CSI prediction procedure; and
transmit a measurement report comprising an indication of a difference between the one or more CSI measurements and the predicted CSI.

15. The apparatus of claim 14, wherein the one or more processors are further configured to cause the UE to:
receive second signaling including an indication of one or more model management procedures associated with the one or more machine learning models in accordance with the measurement report.

16. The apparatus of claim 12, wherein the one or more processors are further configured to cause the UE to:
receive a plurality of reference signals associated with the first plurality of communication resources; and
measure the plurality of reference signals to obtain the plurality of measurements, wherein the report indicates the plurality of reference signals.

17. The apparatus of claim 16, wherein the report includes an indication of one or more skipped measurements of a second plurality of measurements comprising the plurality of measurements, the one or more skipped measurements corresponding to one or more reference signals of the plurality of reference signals.

18. The apparatus of claim 12, wherein the one or more processors are further configured to cause the UE to:
obtain one or more metrics associated with communications between the UE and a network entity in accordance with the predicted CSI; and
transmit the report based at least in part on the one or more metrics satisfying one or more performance thresholds.

19. The apparatus of claim 18, wherein the one or more processors are further configured to cause the UE to:
receive second signaling indicating the one or more performance thresholds.

20. An apparatus for wireless communications at a network entity comprising:
one or more memories storing processor-executable code; and
one or more processors coupled with the one or more memories and configured to cause the network entity to:
output first signaling comprising an indication of a restriction of a set of measurement parameters for inclusion in a channel state information (CSI) prediction procedure at a user equipment (UE); and
obtain a report from the UE comprising an indication of a predicted CSI of a plurality of communication resources in accordance with the CSI prediction procedure and the restriction of the set of measurement parameters included in the CSI prediction procedure at the UE.
